(19) United States
(12) Patent Application Publication
(10) Pub. No.: US 2026/0273751 A1
(43) Pub. Date: Sep. 17, 2026

(54) ADVANCED MANUFACTURING FACILITY FOR HUMANOID ROBOTS

(71) Applicant: Figure AI Inc., San Jose, CA (US)

(72) Inventors: Huiying Zheng, San Jose, CA (US); Vadim Chernyak, San Jose, CA (US); Brett Adcock, San Jose, CA (US)

(21) Appl. No.: 19/565,007

(22) Filed: Mar. 12, 2026

Related U.S. Application Data
(60) Provisional application No. 63/770,654, filed on Mar. 12, 2025.

(51) Int. Cl. B25J 9/16; B25J 19/00; G06N 3/008

(52) U.S. Cl. CPC B25J 9/1674; B25J 9/1692; B25J 19/007; B25J 19/0095; G06N 3/008; G05B 2219/33285; G05B 2219/39001

(57) ABSTRACT

A method of manufacturing a robot includes obtaining a baseline measurement of an operational parameter of an actuated joint, installing a cover over the robot proximate the joint, causing the joint to execute a movement after installation, obtaining a post-installation measurement, determining a difference between the measurements, and evaluating the difference to assess whether the cover has introduced interference with the joint. A method of manufacturing a robot using a computer system includes confirming that a first component has satisfied upstream process conditions prior to testing, performing a component-level test, integrating the first component with a second component, and performing a system-level test on the integrated assembly, with test results from both levels stored in a unified record. A method of manufacturing a robot includes initiating a burn-in sequence on a component, monitoring a performance metric, computing a stability indicator based on variation across operational cycles, and terminating the burn-in upon convergence.

### CROSS-REFERENCE TO RELATED APPLICATIONS

This application claims the benefit of and priority to U.S. Provisional Patent Application Nos. 63/770,654, filed on Mar. 12, 2025, which is fully incorporated herein by reference.

### TECHNICAL FIELD

The present disclosure relates to manufacturing facilities for humanoid robots, and more particularly to a high-volume manufacturing facility designed for efficient production of humanoid robots using advanced automation, modular assembly, and integrated quality control systems.

### BACKGROUND

The modern labor landscape is undergoing a profound transformation driven by an acute workforce shortage, with over 10 million jobs in the United States deemed unsafe, undesirable, or otherwise unappealing for human workers. These positions, prevalent across industries such as manufacturing, construction, agriculture, and logistics, often involve hazardous conditions, repetitive tasks, or physically strenuous duties that pose significant risks to human health and safety. The growing labor gap threatens productivity and operational continuity, necessitating innovative solutions to mitigate workforce challenges. In response, the development and deployment of advanced robotic systems, particularly general-purpose humanoid robots, have emerged as a viable means to address these issues by automating tasks traditionally performed by human workers.

General-purpose humanoid robots are designed with an anthropomorphic structure, typically featuring a bipedal locomotion system, dexterous manipulators, and an interface resembling a human face to facilitate interaction. This human-like form factor allows them to seamlessly navigate and operate within environments designed for people, such as warehouses, construction sites, and healthcare facilities, without requiring significant infrastructure modifications. By replicating human movements, these robots can execute a diverse range of functions, including material handling, assembly, inspection, and caregiving, thereby reducing the need for human intervention in labor-intensive or hazardous occupations. Additionally, advancements in artificial intelligence enable these robots to learn, adapt, and optimize task performance over time, further enhancing their versatility and integration into various industries. Their adoption not only improves workplace safety but also enhances productivity and addresses labor shortages by supplementing the existing workforce.

Despite this progress, several challenges remain in the widespread adoption of humanoid robots, including the high cost of development and production. The scalability of manufacturing humanoid robots is another significant challenge, as traditional production methods may not be optimized for the intricate integration of mechanical, electrical, and software components for these systems. Also, the fragmentation in hardware and software ecosystems creates interoperability challenges, making it difficult for businesses to integrate robots from different manufacturers or scale their robotic workforce efficiently. Therefore, there is a need for an advanced manufacturing facility for humanoid robots.

### SUMMARY

In one aspect, the present disclosure provides a method of manufacturing a robot. The method comprises obtaining a baseline measurement of at least one operational parameter of at least one actuated joint of the robot. Subsequent to obtaining the baseline measurement, a cover is installed over at least a portion of the robot proximate the at least one actuated joint. Subsequent to installing the cover, the at least one actuated joint is caused to execute a movement, and a post-installation measurement of the at least one operational parameter is obtained during or after the movement. A difference between the baseline measurement and the post-installation measurement is determined, and the difference is evaluated to assess whether the cover has introduced interference with the at least one actuated joint.

In another aspect, the present disclosure provides a method of manufacturing a robot using a computer system. The method comprises fabricating a first component of the robot and, prior to testing the first component, confirming via the computer system that the first component has satisfied one or more upstream process conditions. Upon the confirming, a first test is performed on the first component and first test results are stored in a record associated with the robot maintained by the computer system. Subsequent to the first component passing the first test, the first component is integrated with at least a second component to form an integrated robot assembly. A second test is performed on the integrated robot assembly, the second test comprising causing the integrated robot assembly to execute a sequence that evaluates the first component and the at least second component operating as an integrated unit, and second test results are stored in the record. The record maintained by the computer system thereby comprises test results spanning both component-level and system-level validation of the robot.

In yet another aspect, the present disclosure provides a method of manufacturing a robot that includes initiating a burn-in sequence on a component of the robot. The burn-in sequence comprises causing the component to execute repeating operational cycles. During the burn-in sequence, at least one performance metric of the component is monitored, and a stability indicator is computed based on variation of the at least one performance metric across a plurality of the operational cycles. In response to a determination that the stability indicator satisfies a convergence criterion, the burn-in sequence is terminated. A duration of the burn-in sequence is thereby determined based on observed performance behavior of the individual component rather than a predetermined fixed duration. Subsequent to terminating the burn-in sequence, the component is integrated into the robot.

In various implementations of the foregoing aspects, the robot may be a humanoid robot capable of bipedal locomotion, the humanoid robot comprising a plurality of actuators distributed across a torso assembly, at least one arm assembly, and at least one leg assembly. With respect to the cover interference detection aspect, the at least one operational parameter may comprise at least one of a motor current, a joint encoder velocity, or a sensor signal level associated with the at least one actuated joint. Evaluating the difference may comprise comparing the difference against a threshold and, in response to the difference exceeding the threshold, generating a rework indication for the at least one actuated joint. The baseline measurement, the post-installation measurement, and the determined difference may be stored in a digital record associated with the robot that documents performance in both a pre-installation configuration and a post-installation configuration. The baseline measurement may be obtained during a test performed on a subassembly of the robot containing the at least one actuated joint prior to integration of the subassembly into the robot. The method may be performed within a manufacturing facility comprising a manufacturing execution system that tracks the robot through a plurality of production stations and maintains a digital genealogy record for the robot, and the manufacturing execution system may initiate the movement and record the post-installation measurement as part of the digital genealogy record.

With respect to the gated tiered validation aspect and the adaptive burn-in aspect, the first component may comprise an actuator subassembly and the at least second component may comprise a structural subassembly, and the second test may comprise commanding the humanoid robot to execute a locomotion or manipulation sequence. In response to the computer system determining that the first component has not satisfied the one or more upstream process conditions, the computer system may prevent the first test from being initiated and may present a notification identifying an upstream process condition that remains unsatisfied. The second test may comprise supporting the integrated robot assembly such that the robot is not in contact with a ground surface, causing the robot to direct onboard sensors toward features on at least one portion of the robot, and computing calibration corrections based on observations from the onboard sensors relative to a model of the robot, wherein the onboard sensors serve as a metrology instrument for self-calibration of the robot. The calibration corrections may be stored onboard the robot and transmitted to the computer system for inclusion in the record such that the calibration corrections are correlated with upstream process parameters recorded during fabrication.

The computer system may receive telemetry data from the robot after the robot has been deployed, correlate a performance anomaly indicated by the telemetry data with parameters in the record, and generate a corrective action recommendation based on a comparison between the parameters of the robot exhibiting the anomaly and parameters of other robots. The computer system may comprise a predictive module that accepts process parameters recorded during fabrication of the first component and outputs a score representing a likelihood that the first component will fail the first test, and in response to the score exceeding a threshold, the computer system may divert the first component to a diagnostic process prior to the first test. With respect to the adaptive burn-in aspect, the component may be an actuator subassembly comprising a motor and an encoder. The stability indicator may comprise a coefficient of variation computed over a trailing window of a most recent N operational cycles. The at least one performance metric may comprise at least two of a peak torque output, a torque ripple magnitude, a cogging torque amplitude, a thermal rise rate, or an encoder signal quality, and the stability indicator may be computed for each such that the burn-in sequence is terminated in response to the stability indicator satisfying the convergence criterion for each. A non-convergent trend in the at least one performance metric may be monitored during the burn-in sequence, and in response to detecting the non-convergent trend, the burn-in sequence may be terminated with a failure disposition. Converged values of the at least one performance metric and a total duration of the burn-in sequence may be stored in a digital record associated with the component that is associated with a specific robot into which the component is integrated, and subsequent to integration, a system-level performance characteristic obtained during a system-level test on the robot may be correlated with the converged values, whereby relationships between component-level burn-in characteristics and system-level performance are identifiable across a population of manufactured robots.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3 is a perspective view of a humanoid robot of FIGS. 1-2;

FIG. 4 is a high-level diagram illustrating an example facility layout configured as a graphical user interface dashboard that provides for the real-time visualization of production lines and color-coded workstation statuses across the factory floor;

FIG. 5 is a diagram depicting a dedicated station operation screen for station S010, providing an operator with digital work instructions, component identifiers, and real-time performance analytics for a specific assembly unit;

FIG. 6 is a screenshot illustrating a comprehensive performance dashboard displaying line-level cycle times in the top row and cumulative build times across discrete stations in the bottom row, utilizing color gradients for temporal distribution analysis;

FIG. 7 is an example GUI showing a reporting interface configured to generate hierarchical production summaries through the application of time-based filters and equipment path parameters;

FIG. 8 is an example GUI displaying a traceability search interface that allows for the retrieval of a component's build history by querying top-level assembly or housing serial numbers;

FIG. 9 illustrates a graphical tree view of a top-level assembly, providing for the visual exploration of the bill of materials alongside granular process and quality data;

FIG. 10 is a diagram depicting a process plan tree view configured to show the sequential movement of physical parts and system operations;

FIG. 11 is a diagram illustrating an event log interface configured with a search box and navigation button to provide for the auditing of system status changes and operator actions;

FIG. 12 illustrates a working example of an API validation request and response utilized to verify that a part has completed all assembly gates prior to entering end-of-line testing;

FIG. 13 depicts the integration of end-of-line test results into the traceability interface, showing detailed sample metrics such as test identifiers and timestamps within the system dashboard;

FIG. 14 illustrates an end-of-line dynamometer test bed configured for the performance and validation of actuators and associated test computer interfaces displaying real-time testing results;

FIG. 15A illustrates a thumb end-of-line test station in a baseline “straight up” configuration utilized for position sensor calibration and initial motor alignment;

FIG. 15B illustrates another thumb end-of-line test station during a kinetic validation sequence configured to analyze degrees of freedom including flexion, abduction, and articular joint movement;

FIG. 16A illustrates a hand end-of-line test station configured to perform simultaneous digit kinetic validation for range of motion and dexterity across all fingers;

FIG. 16B illustrates another hand end-of-line test station during a power grip validation sequence where the primary digits retract toward the palm while the thumb remains extended;

FIG. 17A illustrates a first full-robot EOL validation station in a calibration pose where the robot raises an arm and looks at its right hand while suspended in a body harness to identify joint offsets;

FIG. 17B illustrates the first full-robot EOL validation station in a calibration pose where the robot looks at its right foot during leg elevation to identify coordinate frame offsets;

FIG. 17C illustrates a second full-robot EOL validation station configured for upper body articular testing, illustrating synchronized head and neck rotation;

FIG. 17D illustrates the second full-robot EOL validation station during waist rotation and simultaneous arm manipulation to verify power and communication stability under articular loads;

FIG. 17E illustrates a third full-robot EOL validation station during a full-body dynamic motion test where the robot is commanded to maintain a running gait; and

FIG. 17F illustrates the third full-robot EOL validation station during a whole-body balancing and coordination test sequence designed to verify autonomous stability.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

Disclosed herein is a modern manufacturing execution system (MES) for building humanoid robots. The manufacturing facility provides a vertically integrated and modular environment specifically configured for the high-volume production of humanoid robots. Rather than utilizing a traditional sequential assembly line, the facility is arranged into parallel production blocks where components and subassemblies are fabricated in independent cells before converging at a central integration zone. This “unboxed” architecture allows for the simultaneous assembly of major modules, such as head and perception units, torso power cores, and limb articulations, ensuring that a throughput of one completed robot can be achieved at high frequency. The layout is further configured to optimize material flow from raw material intake to final testing, utilizing a flat logical flow where specialized lines for actuators, end-effectors, and battery systems feed directly into the heart of the facility. This arrangement provides for a scalable manufacturing footprint that can be reconfigured to accommodate design iterations while maintaining rigorous environmental controls for sensitive electronic and perception components. In alternative embodiments, the facility may occupy a smaller footprint configured as a pilot or prototype production line, or may be expanded to encompass a larger footprint exceeding 100,000 square feet to support higher annual throughput targets. The throughput rate may be adjusted in such alternative configurations to produce fewer or greater numbers of completed robots per unit time, depending on the number and arrangement of parallel production cells deployed within the facility.

Unlike conventional modular manufacturing architectures that focus primarily on the physical joining of large structural sections—such as those employed in vehicle body frame assembly where pre-fabricated panels are bolted or welded together at a mainline—the manufacturing execution system disclosed herein is specifically architected to manage the convergent demands of humanoid robotics production, which involves the simultaneous orchestration of high-density consumer electronics assembly and robust mechanical engineering within a single integrated facility. The MES is configured to serve as a specialized software-based infrastructure that functions as a bridge between enterprise-level planning systems and actual shop floor operations, managing a manufacturing flow that integrates the precision of micro-assembly—including the integration of central processing units (CPUs), graphics processing units (GPUs), tactile sensors, and perception modules—with the structural demands of a larger kinetic platform comprising high-torque actuators, brushless motors, and complex gear systems. This dual-domain management capability distinguishes the disclosed system from prior manufacturing approaches that address either electronic component assembly or heavy structural fabrication in isolation, but not the hybrid convergence of both within a unified production environment. The MES generates dynamic production schedules that account for varying labor and machine requirements across automated stations handling electronic components and manual work cells performing intricate mechanical alignments, thereby providing a synchronized view of production status across fundamentally different assembly modalities. By maintaining comprehensive digital visibility over a manufacturing flow that transforms raw materials into high-functioning humanoid units capable of bipedal locomotion and dexterous manipulation, the disclosed system addresses a manufacturing complexity that is not contemplated by prior modular assembly architectures directed to static structural products.

The manufacturing facility disclosed herein is specifically configured to address the unique production complexity inherent in humanoid robotics, which represents a convergence of high-density consumer electronics assembly and robust mechanical engineering that is fundamentally distinct from the manufacturing challenges addressed by prior modular assembly architectures directed to structural products such as vehicle body frames. Whereas the production of a vehicle body frame involves the joining of a limited number of large structural sections-typically fewer than ten major panels or castings-along defined planar interfaces, the production of a humanoid robot involves the integrated fabrication, assembly, testing, and calibration of a substantially greater number of diverse component types within a single facility, including thirty or more actuators distributed across six or more production lines divided by performance specifications such as momentary peak torque, end-effectors comprising individually articulated digits with multiple degrees of freedom, tactile sensor arrays, battery modules with integrated battery management systems, perception modules incorporating cameras with RGB, depth-sensing, and thermal imaging capabilities, microphone arrays, curved displays, edge-compute electronics incorporating CPUs and GPUs, wireless communication modules, and protective textile cover systems. The inherent complexity of this component diversity is further compounded by the mandate that all of these heterogeneous subsystems must ultimately function as a coordinated kinematic platform capable of bipedal locomotion, dexterous manipulation, environmental perception, and autonomous decision-making, which imposes manufacturing tolerances, calibration constraints, and system-level integration considerations that are not present in the assembly of static structural products. The disclosed facility and MES are therefore configured to decompose this complexity into discrete, station-specific tasks supported by dedicated jigs and fixtures, with specialized environmental controls—including temperature regulation, humidity control, electrostatic discharge protection, and localized cleanroom-class enclosures—provided in dedicated zones for the handling of sensitive components such as optical sensors and edge-compute electronics, ensuring that the assembly environment does not compromise component integrity across the full spectrum of manufacturing modalities.

In some implementations, the manufacturing execution system is configured to monitor production efficiency through a standardized cycle time analysis that provides for the identification of operational bottlenecks across all assembly lines. To determine line-level performance, the system utilizes a mathematical methodology that gathers the minimum cycle times from recent builds at each station and identifies the maximum of these minimum values as the true capacity of the line. This approach allows the facility to establish a target cycle time based on global production goals, which then cascades down into granular requirements for every constituent part, including actuators, structural bodies, and battery modules. Real-time data visualization provided by the system allow managers to compare actual performance against these benchmarks, identifying underperforming segments or gating points that may restrict overall facility throughput. By tracking both individual station cycle times and cumulative build durations, the system provides a data-driven basis for optimizing the manufacturing sequence and ensuring consistent output rates.

Comprehensive production reporting is provided through a hierarchical structure that allows for the analysis of manufacturing data at the facility, line, and part levels. The system is configured to generate summaries that track essential metrics such as total part counts, successful pass rates, and reject quantities, as well as buffer counts that represent inventory residing between discrete processes. These reports allow for deep-dive analysis into specific subassembly cells, capturing operator identifiers, precise timestamps for every station cycle, and finalized test results from end-of-line validation. At the most granular level, top-level assembly reports provide a chronological breakdown of every action taken during a build, enumerating the specific sub-tasks, measurements, and verification steps involved. This reporting infrastructure ensures that all assembly events remain aligned with quality standards and provide the transparency to support large-scale manufacturing oversight and performance auditing.

Traceability and genealogy management within the facility provides a comprehensive digital history for every humanoid robot, linking every constituent part to its respective top-level assembly. This data-driven genealogy is generated in real-time as components are scanned at the initiation of each assembly step, allowing the system to document the precise transformation of materials throughout the manufacturing lifecycle. The system is configured to record granular operational data, including the specific serial numbers of traceable elements, tool-specific torque and angle values for fastening operations, and automated test signatures. This robust lineage allows for the visual exploration of the bill of materials and the inspection of individual process plan steps, providing a transparent audit trail from component intake to final robot calibration. By maintaining such a detailed record, the facility can support rapid root-cause analysis and targeted quality interventions, ensuring that the structural and kinetic integrity of every unit meets rigorous engineering specifications. In further implementations, the traceability data may be leveraged for post-deployment field service operations, warranty claim management, and targeted recall support, wherein the digital genealogy of a specific robot unit may be queried to identify all constituent components and their respective manufacturing histories. This post-deployment traceability may further enable predictive maintenance scheduling by correlating field failure data with the manufacturing parameters recorded during production, such as specific torque signatures or thermal profiles observed during EOL testing. The resulting digital genealogy enables the visual exploration of the complete bill of materials through a graphical tree view interface alongside granular process and quality data for each discrete assembly event, as well as the inspection of individual process plan steps through a separate tree view that utilizes color coding to distinguish between system operations and physical part movements. This end-to-end digital thread—spanning raw material intake, multi-stage assembly, final calibration, and post-deployment service—provides a level of manufacturing transparency and lifecycle traceability that is not contemplated by prior modular assembly architectures that do not disclose any mechanism for part-level scanning, digital genealogy generation, or the preservation of granular assembly and test data.

In some implementations, system monitoring and operational auditing are facilitated through an integrated event logging framework that provides for the tracking of all digital and physical interactions on the shop floor. The system is configured to preserve a chronological record of manufacturing events, including status changes, hardware or software errors, and specific operator actions taken at various workstations. This logging capability allows for the monitoring of security-related events, such as web authentication changes and login requests, as well as automated data writes from connected tooling and machinery. Users can perform targeted queries within the logs to isolate information regarding specific part numbers, serial numbers, or station identifiers, which provides for the rapid retrieval of diagnostic data for troubleshooting and system optimization. This continuous monitoring infrastructure ensures that the facility's digital twin remains synchronized with physical operations, providing a secure and transparent ledger of the entire robotic production environment. In some implementations, the event logging framework may further support configurable data retention policies that define how long event records are preserved before being archived to long-term storage or purged in accordance with applicable regulatory or compliance standards. The archived event data may be exported in standardized formats, such as comma-separated value (CSV) files or structured JavaScript Object Notation (JSON) documents, for integration with external compliance reporting systems or regulatory audit platforms. In some embodiments, the retention policy may define a tiered archival strategy wherein recent event data is maintained in a high-availability database for rapid query access, while older records are migrated to lower-cost archival storage after a configurable threshold period. This continuous event logging and digital twin synchronization capability provides a level of manufacturing process transparency and auditability that enables the facility to maintain an accurate digital representation of all factory floor operations, further supporting the types of root-cause analysis and quality interventions described elsewhere in this disclosure.

The end-of-line (EOL) testing phase provides the final validation stage for both individual components and the fully integrated humanoid robot, ensuring that every unit meets the functional specifications before leaving the production environment. Within this framework, the MES is configured to own the complete process history for each part and serves as the authoritative system for validating part readiness prior to the initiation of EOL sequences. The testing hardware, or tester, is responsible for initiating the test by scanning the part barcode, collecting real-time performance data, and managing the front-end interactions for the operator. This distributed architecture allows the MES to receive and store finalized test results while providing the tester with the top-level assembly (TLA) information to determine the specific test suite to be executed. By leveraging this integration, the facility can support a variety of specialized EOL stations, such as those dedicated to the Actuator 1-6 lines, where actuators and structural subassemblies undergo rigorous verification of their kinetic and electronic capabilities.

Communication between the EOL tester and the MES is facilitated through dedicated API endpoints for validating parts and posting results. The validation step allows the system to confirm that a part has successfully navigated all preceding assembly gates, such as the designated battery process steps, before it can proceed to the final test. This automated handshake ensures that no unit bypasses the manufacturing steps and provides the tester with the precise context needed for test execution. In the event that the validation request returns a failure response indicating that the part has not cleared all upstream assembly gates, the system is configured to prevent the initiation of the EOL test sequence and to present a notification to the operator identifying the specific upstream step that remains incomplete. If a network interruption occurs during the communication between the tester and the MES, the system may be configured to execute a retry protocol comprising a configurable number of reattempted transmissions at defined intervals before escalating the event to a supervisory operator for manual resolution. Upon the successful completion of the test sequence, the tester is configured to submit the results to the MES via the posting results endpoint. These results are then integrated into the product's digital genealogy and can be reviewed through the MES traceability interface. This level of detail provides for a comprehensive audit trail, as the MES appends all EOL test data, including any subsequent retests, to the unit's permanent record, ensuring that quality assurance teams can track the performance of every actuator and subassembly throughout its entire lifecycle. This distributed validation architecture—wherein the MES maintains authoritative process history while the tester manages front-end operator interactions and real-time data collection-provides a quality gating mechanism that enforces assembly sequence compliance prior to final validation, ensuring that no unit consumes testing resources until all upstream assembly conditions have been satisfied.

The EOL testing framework also extends to the full robot assembly, where the MES is configured to manage the mapping of unique TLA serial numbers to specific robot identifiers. During the full robot validation stage, the tester scans the robot-level TLA PN/SN - - - which is utilized as the primary identifier because the hand barcodes may be obscured by soft goods installation - - - and the MES returns the associated mapping data, including the main robot controller (MRC) and torso identifiers. This interface can be configured to show daily production volume trends and peak production days, allowing management to monitor the overall health of the production lines and identify any recurring failure patterns that may influence manufacturing effectiveness.

The implementation of a robust EOL testing and reporting system provides significant benefits for quality control and operational efficiency across the facility. By isolating failure modes at the final stage of production, the system allows for the early detection of defects that may have originated in upstream assembly or component fabrication. This capability provides a data-driven basis for implementing corrective actions in the manufacturing process, thereby reducing the likelihood of field failures and enhancing the overall reliability of the humanoid robots. Additionally, the centralized storage of test results within the MES enables long-term performance analytics, where engineers can correlate EOL test signatures with real-world gait analysis and motor skill assessments. This continuous feedback loop provides for the ongoing optimization of both the robotic designs and the manufacturing methodologies, ensuring that the facility maintains its high-volume throughput targets while delivering high-quality, functional robotic platforms.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

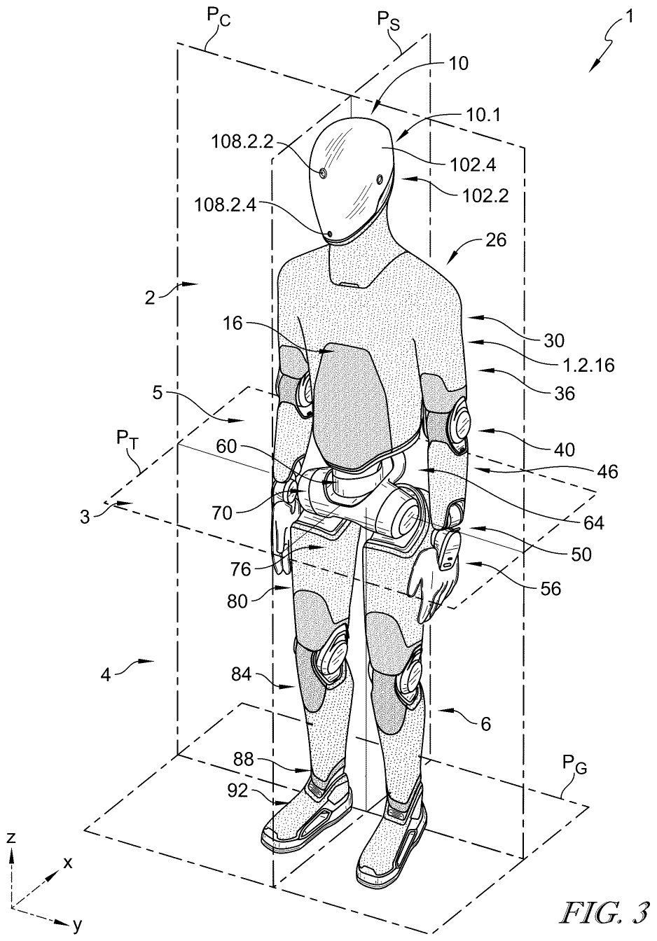

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3.

Extended State: a state of the robot with the arms extended outward laterally at the shoulder and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3) is a vertical plane positioned at a midway point between the left and right legs and the left and right arms and contains a rotational axis A₁₀ of a torso twist actuator (J10) located in the spine 60 of the robot 1 and divides the left and right sides of the robot 1 (e.g., as illustrated in FIG. 3). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contain an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3 illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bn): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

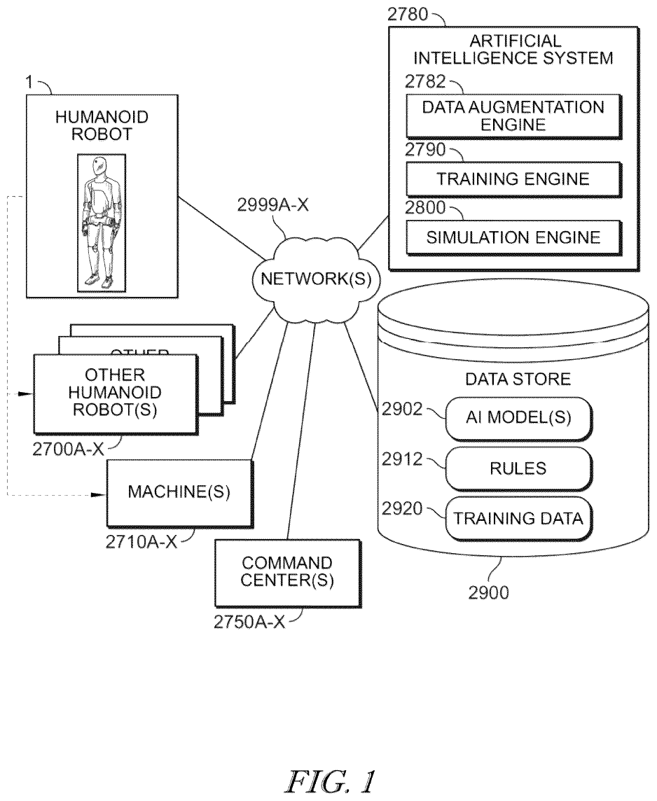

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800. In some embodiments, one or more of these engines may be deployed on dedicated hardware accelerators, such as GPU clusters or tensor processing units, to facilitate the computational demands of large-scale model training and simulation.

### D. Humanoid Robot

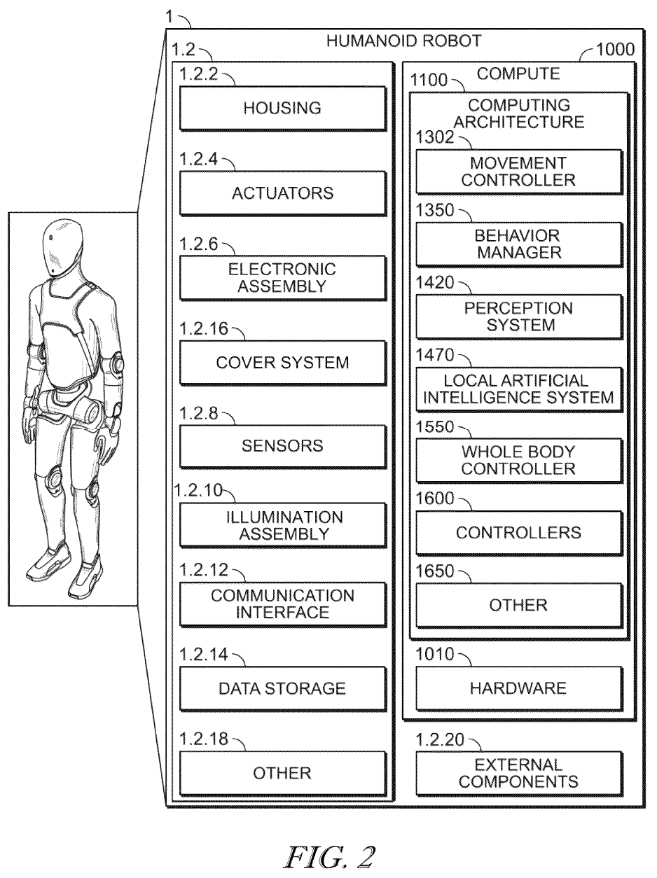

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3 may include the following systems, assemblies, components, and parts, which can be broadly categorized into three regions. As shown in FIG. 3, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (P_{S}) but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (P_{S}). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans - - - for instance, by emitting light that appears to humans in different colors (e.g., yellow for working, green for idle, red for an error state, or blue for thinking) or illumination sequences - - - without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers). Internal cable routing channels may be integrated within the arm assembly housings to guide electrical wiring and sensor harnesses from the hand 56 through the forearm segments and into the torso 16, thereby protecting the cabling from mechanical wear during joint articulation and simplifying the assembly process during manufacturing. In some embodiments, the arm assemblies 5 may incorporate tactile sensor wiring that is routed along the exterior surface of the forearm segments and secured with clip-on retainers or adhesive guides, which may facilitate easier replacement of tactile sensor arrays during field service operations.

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers). In alternative embodiments, the foot 92 may be configured with interchangeable sole inserts that provide different traction characteristics for various operating surfaces, such as smooth indoor floors, outdoor terrain, or anti-static environments. The talus 88 and foot 92 assembly may further incorporate force-sensing elements that are validated during the leg assembly process and subsequently re-verified during the shin EOL testing sequence to confirm that gait-related force measurements fall within acceptable tolerance bands.

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide information on the orientation and acceleration of each leg segment, thereby allowing for the precise control of leg positioning during movement.

### E. MES for Humanoid Robot

The manufacturing execution system (MES) provides a specialized software-based infrastructure configured to monitor and control the unique production demands of humanoid robotics, serving as a functional bridge between enterprise-level planning systems and actual shop floor operations. Unlike traditional automotive manufacturing, which often relies on heavy machinery and large-scale industrial robots for processes like stamping and welding, humanoid production represents a convergence of high-density consumer electronics assembly and robust mechanical engineering. The MES is configured to interface with enterprise resource planning (ERP) systems through standardized data exchange protocols, such as message queuing or RESTful API calls, that allow production schedules and material requirements to be synchronized between the planning layer and the shop floor execution layer. The system is configured to manage a complexity comparable to advanced smartphone manufacturing - - - integrating sophisticated components such as central processing units (CPUs) and graphics processing units (GPUs) - - - while simultaneously accounting for a significantly higher volume of kinetic parts, including larger actuators, brushless motors, and complex gear systems. This digital architecture allows for comprehensive visibility over a manufacturing flow that integrates the precision of micro-assembly with the structural demands of a larger kinetic platform, providing for the real-time tracking of raw materials as they are transformed into high-functioning humanoid units.

Operational management within this hybrid facility is enhanced by an MES specifically configured to balance high-precision automation with specialized manual engineering. While electronic components and small sensors allow for traditional automated assembly, the integration of high-torque actuators and structural limbs involves substantial lifting and intricate mechanical alignments that can require human-led engineering interventions. The MES generates dynamic production schedules that consider these varying labor and machine requirements, assigning specific work orders to workstations while providing operators with precise digital instructions for complex tasks such as planetary gear alignment or battery busbar integration. Real-time interfaces allow the system to collect metrics from both automated stations and manual work cells, providing for a synchronized view of production status. This configuration allows the system to manage the movement of heavy structural frames alongside delicate tactile sensors, ensuring that the assembly process maintains the tolerances without sacrificing the throughput needed for high-volume production.

The transition toward smart manufacturing in the humanoid space is supported by digital features within the MES that allow for the seamless integration of hardware assembly and software deployment. Given that each robot serves as a mobile edge-computing platform, the MES is configured to manage the flashing of firmware and the calibration of perception systems in parallel with physical build stages. AI and machine learning algorithms can be utilized to process data from diverse sources - - - from the torque signatures of a leg actuator to the signal integrity of an onboard GPU - - - allowing for the optimization of production outcomes through predictive analytics. Enhanced user interfaces, including 3D visualization and augmented reality (AR), provide operators with the intuitive tools to manage the complexity of hundreds of moving parts and sensors within a single unit. For example, an AR-equipped operator headset or tablet may overlay digital annotations onto the physical subassembly, highlighting the precise location and orientation for the next fastening point, the designated torque specification for the current bolt, or the routing path for a cable harness, thereby reducing the cognitive load on the operator and decreasing the incidence of assembly errors. By integrating with product lifecycle management (PLM) tools, the MES facilitates an information flow that ensures the manufacturing process accommodates the unique interplay between mechanical precision and software-driven performance, fostering a culture of continuous improvement. In some implementations, the MES may exchange data with PLM systems at configurable synchronization intervals, such as upon completion of each station cycle or at predefined batch boundaries, to ensure that engineering change orders and design revisions are reflected on the shop floor with minimal latency. The parallel management of software provisioning alongside physical assembly—and the MES's role as the central orchestrator of both domains—addresses a manufacturing consideration that is unique to products that are simultaneously mechanical platforms and autonomous computing systems.

In some implementations, the MES is configured with an adaptive line rebalancing engine that dynamically adjusts station-level work content assignments and cycle time targets in response to changes in the robot configuration variant being produced on the modular assembly lines. The humanoid robot platform may support a plurality of configuration variants that differ in actuator types, end-effector configurations, sensor packages, battery capacities, or software feature sets, where each variant may involve a different distribution of assembly work content across the stations of a given production line. The adaptive line rebalancing engine maintains a library of variant-specific process plans, each defining the set of assembly operations, their precedence constraints, and their estimated cycle times for every station. When the MES receives a production order specifying a transition from a first robot configuration variant to a second robot configuration variant, the rebalancing engine computes an optimized station assignment map for the second variant by solving a constrained optimization problem that minimizes the maximum station cycle time across the line subject to precedence, tooling, and operator skill constraints. The rebalancing engine then propagates the updated work content assignments to the station-level operation screens, updating the digital work instructions presented to operators and recalculating the target cycle times displayed on the performance dashboard. This dynamic rebalancing occurs without physical retooling of the production line, leveraging the modular fixture and jig architecture to accommodate variant-specific assembly sequences through software-defined reconfiguration. In some embodiments, the rebalancing engine may further incorporate a predictive scheduling component that pre-computes station assignment maps for anticipated variant transitions and pre-positions the tooling and components at each station in advance of the transition, thereby minimizing changeover time. In further embodiments, the engine may optimize across multiple production lines simultaneously, redistributing work content between parallel lines to maintain balanced throughput when variant mix ratios change during a production campaign.

a. Facility Layout

The manufacturing facility described herein provides a high-volume production environment specifically configured for the fabrication, assembly, and testing of humanoid robots. Occupying approximately 60,000 square feet, the facility utilizes a vertically integrated manufacturing architecture that allows for comprehensive control over the entire build process, from raw material intake to the delivery of calibrated, high-functioning robotic units. In a primary configuration, the facility can support the manufacture of up to 12,000 humanoid robots annually, which translates to a throughput of one completed robot every 20 minutes. This rate is enabled by high-frequency upstream feeder lines, where components such as robotic fingers can be produced every 2 minutes and specialized actuators are completed every 40 seconds. To achieve these metrics, the inherent complexity of humanoid robotics is decomposed into discrete, station-specific tasks supported by dedicated jigs and fixtures that allow for rapid assembly and consistent quality. Each robotic part is configured for optimized assembly flow, ensuring that tool access and cycle times are minimized. By reimagining the mechanical and electrical systems, the total part count is reduced through the elimination of various fasteners, redundant sensors, and printed circuit board assemblies (PCBAs), leveraging high-rate manufacturing methodologies derived from the automotive and consumer electronics industries.

The physical layout of the facility is configured to optimize material flow, initiating with strategically positioned warehouse access points that provide for the efficient delivery of raw materials to initial assembly stations. For example, actuator production lines and subassembly lines are arranged to converge into a central robot assembly and test main line. The actuator lines focus on the production of motion components that provide for the range of movement by the humanoid form, while subassembly lines integrate these actuators with sensors and structural elements to create larger functional units such as limbs and torsos. These modular subassemblies can undergo rigorous testing and calibration before being integrated into the final assembly, which allows the system to verify that each module meets performance criteria independently of the whole. This modularity ensures that the facility is scalable, as the architecture allows for the expansion of production capacity through the addition of new lines or the reconfiguration of existing ones to accommodate design iterations or fluctuating market demand. Material transport between production cells may be facilitated by automated guided vehicles (AGVs), conveyor systems, overhead gantry mechanisms, or manual cart-based transfer, depending on the weight and fragility of the subassemblies being moved. In some configurations, the AGVs may be integrated with the MES to receive dynamic routing instructions based on real-time production status and buffer levels at each cell.

The disclosed manufacturing facility is configured with a scalable and dynamically reconfigurable production architecture in which the MES actively manages the routing of materials to specialized subassembly lines based on real-time production status, buffer levels, and functional macro-module designations, rather than relying on a static, predetermined flow path. The MES is configured to monitor buffer counts—representing the quantity of components residing between discrete processes or stations—and to dynamically route materials to specialized subassembly lines based on functional macro-modules such as head and perception cells, torso and core power cells, and limb and articulation cells, thereby allowing the facility to respond in real time to production variances, equipment availability changes, or quality-related diversions without halting the overall modular process. Material transport between production cells may be facilitated by the automated guided vehicles that are integrated with the MES to receive dynamic routing instructions based on real-time production status and buffer levels at each cell, as well as by conveyor systems, overhead gantry mechanisms, or manual cart-based transfer depending on the weight and fragility of the subassemblies being moved. The facility architecture further supports scalable reconfiguration, wherein production capacity may be expanded through the addition of new parallel lines or the reconfiguration of existing lines to accommodate design iterations or fluctuating demand, with the MES managing the integration of new production cells into the existing digital infrastructure without a redesign of the overall manufacturing workflow.

Advanced manufacturing technologies are deployed throughout the facility to enhance precision and operational efficiency. Automated assembly systems, multi-axis robotics, and computer-controlled machinery are distributed across various production stages to handle repetitive or high-precision tasks. Reconfigurable elements within the production lines allow for rapid adaptation to design changes, which can minimize downtime associated with retooling. By maintaining in-house development of motion and control systems, the facility can support rapid iteration cycles based on real-time production feedback and performance analytics. Specialized environmental controls are provided in dedicated zones for the handling of sensitive components, such as optical sensors and edge-compute electronics, ensuring that the assembly environment does not compromise component integrity. These environmental controls may include temperature regulation within a range of 20° C. to 25° C., humidity control maintained between 30% and 50% relative humidity, electrostatic discharge (ESD) protection through grounded workstations and personnel grounding straps, and localized cleanroom-class enclosures for the assembly of perception modules and camera systems.

The facility's digital infrastructure integrates real-time data analytics, augmented reality systems for maintenance, and collaborative platforms for inter-team coordination. This infrastructure provides for a culture of continuous improvement, allowing for dynamic enhancements in both the manufacturing process and the robotic designs themselves. Modern humanoid manufacturing within this facility relies on a parallel, modular framework, sometimes referred to as an “unboxed” process. In this configuration, large subassemblies are produced in independent cells and converge only at the final integration stage, ensuring that a quality issue identified in one module does not necessarily halt the operations of the entire factory. The disclosed MES can dynamically route materials to these specialized subassembly lines based on functional macro-modules, such as head and perception cells, torso and core power cells, and limb and articulation cells.

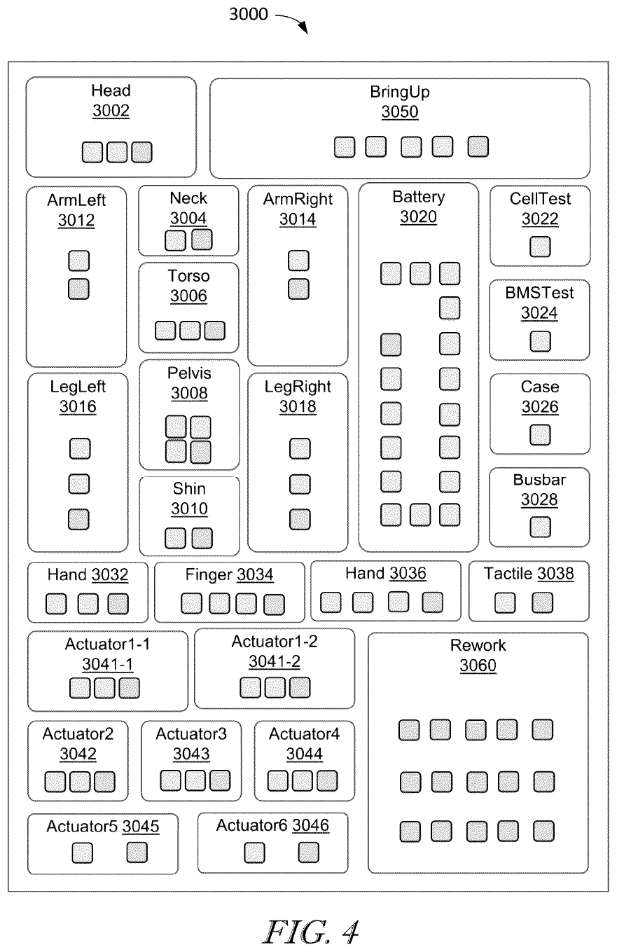

Referring to FIG. 4, the example facility layout 3000 can be further characterized as a graphical user interface (GUI) dashboard provided by the MES for real-time operational oversight. Upon user authentication and login, the system is configured to present a landing page comprising the overall BotQ facility layout 3000, which provides for the visualization of key information related to the current production state. Instead of traditional sequential production lines, the layout 3000 provides for blocks of component lines laid flat in a logical flow that mirrors the robotic architecture. This configuration facilitates a modular “unboxed” process where subassemblies are built in parallel. The layout includes a plurality of actuator lines, specifically Actuator 1-1 3041-1, Actuator 1-2 3041-2, Actuator 2 3042, Actuator 3 3043, Actuator 4 3044, Actuator 5 3045, and Actuator 6 3046. These blocks can be divided into distinct product lines based on momentary peak torque or other performance specifications, with lines 1-1 and 1-2 configured for the production of larger volume motion components. Adjacent to these actuator lines are end-effector lines, including a dedicated column for Hand Assembly 3032, Finger 3034, Hand Integration 3036, and Tactile 3038. The Hand Assembly line 3032 is configured for the initial construction of the hand subassembly including palm structure and digit integration, while the Hand Integration line 3036 is configured for the subsequent integration of the hand subassembly with wrist and forearm interface components.

The spatial arrangement in layout 3000 is configured such that peripheral subassemblies surround a core integration sequence to form the humanoid structure. In this example, the Head 3002, ArmLeft 3012, ArmRight 3014, LegLeft 3016, and LegRight 3018 lines are positioned to encompass the central processing and skeletal cells. These inner cells include the Neck 3004, Torso 3006, Pelvis 3008, and Shin 3010 lines, which together constitute the primary structural backbone of the humanoid platform. This arrangement allows the various macro-modules to flow from independent production blocks toward a central area where they can converge into the final assembly and test lines. Each block on the dashboard is represented as a series of discrete stations, depicted as small squares, where each square corresponds to a specific physical location on the factory floor and is associated with a unique station number for identification. The interface is configured to allow a user to click on specific production lines, such as BatteryMain1 or Actuator 1-2, which triggers a zoom-in function to a detail view of the selected line, as illustrated by the zoomed-in view of the Head line 3002.

The rightward region of the layout 3000 is dedicated to energy management and support infrastructure, providing specialized blocks for the Battery sector and post-assembly validation. The battery lines include the main Battery line 3020, CellTest 3022, BMSTest 3024, Case 3026, and Busbar 3028. These lines are configured for the fabrication and rigorous functional validation of energy storage modules before they are integrated into the Torso 3006 backbone. At the top of the layout, a BringUp 3050 area is provided to manage the initial software provisioning and calibration of completed robots, while a dedicated Rework 3060 zone at the bottom provides for the debugging and troubleshooting of any unit that fails to clear the various end-of-line quality gates. This comprehensive digital twin of the factory floor, with its color-coded status indicators and cascading data metrics, allow for the real-time management of a production flow that integrates high-precision automation with manual engineering precision.

The BringUp 3050 area is configured to manage the transition of a completed robot from a mechanical and electrical assembly into a fully operational platform through a sequence of software provisioning and system initialization steps. This sequence may include the flashing of firmware onto the robot's onboard compute 1000 and motor controllers, the initialization and verification of the perception system including camera and microphone calibration, the registration of the robot's unique identity and network credentials with the command centers 2750A-X, and the execution of an initial self-test routine that confirms the functional status of all actuators, sensors, and communication modules. Upon successful completion of the bring-up sequence, the MES may update the robot's digital record to reflect its readiness for deployment or delivery. In some embodiments, the bring-up sequence may further include the loading of initial AI models 2902 onto the robot's local compute, as well as the configuration of safety parameters and operational rules 2912 specific to the robot's intended deployment environment. The MES coordinates data exchange with product lifecycle management systems at configurable synchronization intervals to ensure that engineering change orders and design revisions affecting firmware or AI model configurations are reflected on the shop floor with minimal latency, further supporting the parallel management of software provisioning alongside the physical assembly stages occurring on the production floor.

The MES dashboard is configured to provide real-time workstation status through a sophisticated color-coded visualization system. For instance, a flashing red state can signify that a safety circuit is not OK, such as when an emergency stop is engaged or a protective door is open. A solid red square indicates a faulted station, while yellow denotes a station in manual mode that is not currently running in auto. Performance-related feedback is provided through light grey for a primary starved state and orange for a blocked state, where a part remains in the station despite the completion of all work content. A pink fill is used to indicate an overcycle condition, while green confirms that a station is running with a part in progress within the expected cycle time. The interface also provides for operator support, where a yellow border around a station square indicates an operator call for help, and a darker grey fill signifies that the station is currently off-shift and inactive. A white fill may be used to represent a station that is not currently occupied. In response to these color-coded states, the MES may be configured to initiate automated response protocols tailored to the nature of the indicated condition. For example, when a station enters the faulted state indicated by a solid red square, the system may generate an automated notification to a maintenance supervisor and simultaneously log a fault event in the event log interface 4200 with the station identifier, timestamp, and fault code. When a blocked state is detected, the MES may alert the downstream station operators and trigger a buffer management assessment to determine whether material should be rerouted to an alternative production cell. When an overcycle condition is indicated by the pink fill, the system may flag the station for cycle time review and prompt the station operator to confirm whether additional assistance or tooling support is needed. This combination of granular real-time visualization with automated, condition-specific escalation protocols provides active factory floor management that enables the facility to detect and respond to operational variances without manual supervisory intervention at every station.

Directly beneath the descriptive name of each production line, the MES is configured to display production data that includes part counts comparing actual output against weekly targets. In one configuration, a display such as “50/60” illustrates the relationship between the actual number of units completed and the target threshold for the specified period. These targets are configured to cascade from high-level institutional goals - - - such as target robot counts per hour, day, and week - - - down into granular requirements for constituent components, including specific counts for actuators, structural bodies, and battery modules. The “Actual” metric within this interface refers to the total pass count of units that have successfully cleared the quality and assembly gates for that specific line. The dashboard interface can also provide information regarding buffer counts, which represent parts that have been produced and passed inspection but are not yet consumed by downstream integration processes. These buffer counts allow the MES to dynamically route materials to specialized subassembly lines based on functional macro-modules such as head, torso, and limb cells.

The spatial arrangement in layout 3000 further illustrates that the leftmost columns comprise a plurality of actuator production lines, which may include seven distinct lines. For instance, thirty actuators - - - excluding those dedicated to hand end-effectors - - - can be divided across six production lines based on performance specifications such as momentary peak torque (N-m). Specific lines, such as Actuator 1-1 and 1-2, are configured for the production of larger actuators requiring higher torque outputs or larger form factors. Adjacent to these are the end-effector lines, which include production blocks for tactile sensors, thumbs, fingers, and hands, arranged as a dedicated column. To the right of these component lines, specialized blocks for neck, shin, arm, and leg subassemblies (both left and right) are positioned to surround the central integration area. This central area is configured to handle the pelvis and torso assembly lines, which converge into the final assembly and test lines. The right side of the layout 3000 is dedicated to battery-related production, including lines for the battery management system (BMS), battery cell testing, case preparation, and busbar subassemblies. At the bottom of the layout, dedicated rework and “bring-up” lines are provided to handle units requiring additional calibration or repair. As shown in the zoomed-in view of the Head line 3002, the battery main line is configured as a ring structure containing dozens of individual workstations, allowing for a continuous, circulating assembly process where battery modules can be built and tested within a compact, high-efficiency footprint.

b. Production Line Cycle Time

The MES provides for a seamless transition from the macro-level facility overview to granular station-level operations through an interactive digital interface. When a user or operator selects a specific station icon within the larger facility layout, the system is configured to open a dedicated operation screen 3200, as illustrated by the actuator assembly page for station S010 of the Actuator 1-2 line in FIG. 5. This screen 3200 serves as the primary operational hub, providing essential tracking data in a designated region 3202 such as the top left, including a unique robot serial number and the specific part number assigned to the current build. By centralizing these identifiers, the system allows for the maintenance of a comprehensive digital genealogy for every unit produced, ensuring that every assembly event is logged against the correct asset. The interface is further configured with a centralized panel for work instructions and a performance monitoring window, ensuring that the operator remains informed of both the technical requirements and the temporal performance targets associated with the specific task.

Within the central work instruction panel 3204 of FIG. 5, the system provides discrete, sequential guidance for the assembly of complex subassemblies, such as the smart joint actuator. For example, at station S010, the instructions may specify that the operator is to press a bearing into the output plate before applying a light layer of grease on the inner face of the output plate. Subsequent steps allow for the installation of the output plate onto the actuator body, where the operator is guided to locate the rod in the middle position to ensure proper alignment before final fastening. To finalize the mechanical integration, the system provides instructions to use six M3 5×12 button head bolts and secure the assembly in a specific cross pattern, which minimizes internal stresses and ensures structural integrity. Once these primary steps are completed, the operator may interact with a prominent confirmation button 3206, often highlighted in a color such as purple, to signal task completion and advance the build cycle. To support the high-precision requirements of humanoid construction, an auxiliary panel 3208, located in the bottom right corner of the interface, is configured to list more detailed assembly steps and micro-measurements that the operator can follow once the main instruction has been confirmed.

The operation screen 3200 in FIG. 5 further includes real-time performance analytics 3210, positioned in a corner such as the bottom left, which displays the average cycle time of the most recent parts processed at the station, such as the last ten builds. This data can be visualized through bar charts 3212 to illustrate trends and variability relative to the target cycle time, allowing the operator and management to identify anomalies or areas for process optimization. By providing this combination of macro-instructions and micro-level operation lists, the MES allows for a hybrid assembly environment where automated data capture and manual engineering precision can coexist. This granular visibility at the station level supports a continuous improvement loop that optimizes the overall manufacturing effectiveness, ensuring that each of the thousands of discrete steps for a humanoid build is executed according to predefined standards while maintaining the throughput for the facility.

The aggregation of this station-level performance data allows the MES to perform complex line-level cycle time calculations that ensure the entire facility remains synchronized with global production targets. A target cycle time for each production line is established based on the required robot output for a given week, and the system is configured to calculate the actual line performance using a specialized Max-Min methodology. For any designated production line X containing a set of stations S={s₁, s₂, . . . , s_{Y}}, the system first determines the minimum cycle time recorded for the most recent builds at each constituent station, following the removal of statistical outliers. Statistical outliers may be identified using a threshold-based approach, such as flagging any cycle time that deviates from the station mean by more than a configurable number of standard deviations (e.g., two or three standard deviations), or by applying an interquartile range (IQR) method wherein cycle times falling below the first quartile minus a multiplier of the IQR or above the third quartile plus a multiplier of the IQR are excluded from the calculation. Let CTₛ_{ᵢ} represent the set of cycle times for the last five builds at station sᵢ after outlier filtering. The system computes a station-specific minimum mₛ_{ᵢ}=min(CTₛ_{ᵢ}) for all stations in S. The set of these minimum values, M={mₛ_{₁}, mₛ_{₂}, . . . , mₛ_{_{Y}}}, is then analyzed to identify the maximum value within the set. The line-level actual cycle time is thus defined as the maximum of these minimums:

$$LineX\_Actual \_Cycle \_Time = max ( M ) = max \{ min ( C {T}_{{s}_{1}} ) , min ( C {T}_{{s}_{2}} ) , … , min ( C {T}_{{s}_{Y}} ) \} .$$

effectively identifies the inherent capacity-limiting station within the modular “unboxed” process by isolating the station whose best-case performance represents the binding constraint on overall line throughput, rather than relying on average-based metrics that may obscure the true bottleneck due to variability across stations. This mathematical approach provides for the identification of specific areas for improvement while ensuring that the overall throughput targets are maintained through data-driven operational management. In alternative implementations, the system may employ other cycle time calculation methodologies, such as a median-based approach that computes the median cycle time across all stations to provide a measure of central tendency that is less sensitive to extreme values, or a weighted average methodology that assigns greater weight to stations with higher variability or historical defect rates. The selection of a particular cycle time methodology may depend on the characteristics of the production line and the specific performance optimization objectives of the facility.

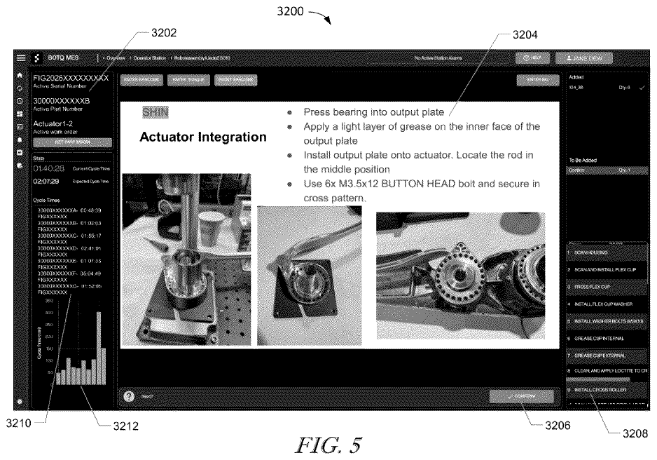

At the aggregate line level, the MES can be configured to provide continuous tracking and visualization of performance metrics through a dedicated performance dashboard 3400, as illustrated in the example performance chart of FIG. 6. This interface displays, on the top row, the Max-Min cycle time for each production line 3402, 3404, and 3406, derived from the mathematical calculations previously described, and utilizes distinct color coding to facilitate rapid comparative analysis. For example, the cycle time chart is configured such that the target cycle time is represented in a blue color, providing a consistent baseline for institutional performance expectations. The actual cycle time, reflecting the real-time operational performance of the line, is depicted in a cyan color, allowing for a direct visual contrast between current output and planned targets. To enable robust performance benchmarking, the system compares these observed cyan values against the blue target values, which can be established based on specific production milestones, such as a goal to build one completed humanoid robot per day. The MES may allow for the dynamic adjustment of these targets to align with shifting production plans, providing management with the ability to identify which production lines are currently underperforming or functioning as gating points that restrict the facility's overall ability to reach its throughput objectives.

Beyond the monitoring of overall cycle times in the top row, the performance dashboard 3400 in FIG. 6 also provides for the calculation and visualization of total build time 3412, 3414, and 3416 in the bottom row. This section of the interface aggregates the individual cycle times of each station as a component, such as an actuator or battery part, moves through the production sequence. The build time is visualized using a color gradient or varying colors to distinguish between different stations and lines, where specific segments - - - such as those corresponding to S010 build time, S020 build time, or S030 build time in bar chart 3412 - - - illustrate the actual duration a part resides at each discrete station relative to the aggregate benchmarks. This multi-colored representation provides a precise visualization of how build time is distributed across the entire manufacturing lifecycle, allowing for an assessment of process efficiency at every stage. By providing this granular insight, the system enables the identification of specific workstations that may benefit from task optimization or further decomposition of work content. This comprehensive approach to data visualization ensures that build times remain consistent with the facility's high-volume requirements while providing the transparency to support iterative process improvements across the “unboxed” modular framework.

c. Production Reports

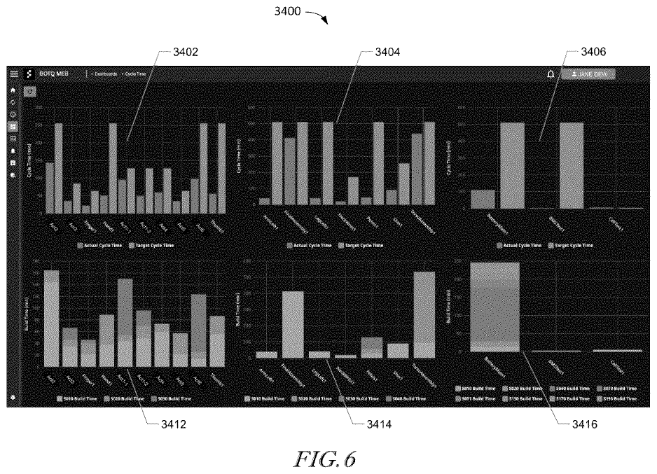

The MES is further configured to provide access to comprehensive production reports through a dedicated statistics interface, accessible via a designated icon in the system sidebar. As illustrated in the reporting interface 3600 of FIG. 7, the system allows for the generation of reports at multiple hierarchical levels to support varying management and engineering requirements. These levels include a high-level facility summary, detailed line-specific reports 3602, and granular top-level assembly (TLA) reports focused on individual parts or housings. The interface is configured with a set of filtering parameters that allow a user to define the desired time range by selecting start and end dates, as well as an equipment path filter to isolate data from specific stations or production areas. Upon setting these parameters, the system can initiate the report generation process, during which a loading indicator is presented until the finalized data is displayed in a viewing pane on the right side of the interface. This visual architecture allows for the rapid retrieval of performance data while maintaining the flexibility to adjust column widths for optimized readability.

A plant-level summary report provides a broad overview of manufacturing performance across all active production areas, including robot assembly, battery production, end-of-line (EOL) testing, and specialized bring-up or rework zones. The system is configured to track and display essential metrics for each line, such as the total count of parts processed, the successful pass count following inspection or testing, and the reject count for units failing to meet performance criteria. Additionally, the report provides visibility into buffer counts, which represent the quantity of components residing between discrete processes or stations, allowing for the identification of potential inventory imbalances. Cycle time metrics, including minimum, maximum, and average values, are integrated into this summary to provide a data-driven basis for assessing facility-wide efficiency and quality trends. This high-level visibility allows stakeholders to quickly identify operational variances across large-scale modules like RobotAssembly1 or Battery1.

Line-specific summary reports are configured to provide deeper insights into the production activity of individual subassembly lines, such as the Actuator 1-2 or TorsoAssembly1 cells. These reports include detailed identifiers such as the specific area name, work order numbers, and serial numbers for both the top-level assembly and associated housing components. The system is configured to record the status of each station as a pass, fail, or not applicable result, while also capturing the unique operator identifiers and cycle times for every assembly stage. Timestamps for both the start and completion of individual station cycles, as well as the overall TLA build duration, are preserved within the report to facilitate precise temporal analysis. For units reaching the end-of-line stage, all test data, including any subsequent retests, is appended to the report to ensure full traceability throughout the final validation phase.

For the most granular level of analysis, the TLA report provides a step-by-step breakdown of the entire assembly process for a specific unit, enumerating the sequence of actions taken at each workstation. The report includes operation descriptions for clearly labeled steps, such as the installation of a flex cup, the pressing of a rotor, or the scanning of a main logic board (MLB). For each step, the system records the part numbers, descriptions, and quantities of components used, along with the serial numbers for traceable elements such as wave generators or encoders. This reporting level is further configured to capture tool-specific data, including the tool name, the designated preset configuration (Pset), and the recorded torque and angle values for every fastening operation. By integrating these pass/fail flags with detailed torque signatures and component genealogy, the MES allows for the validation of all assembly steps against rigorous quality standards, providing a comprehensive audit trail for every humanoid robot produced within the facility.

d. Traceability & Genealogy Data

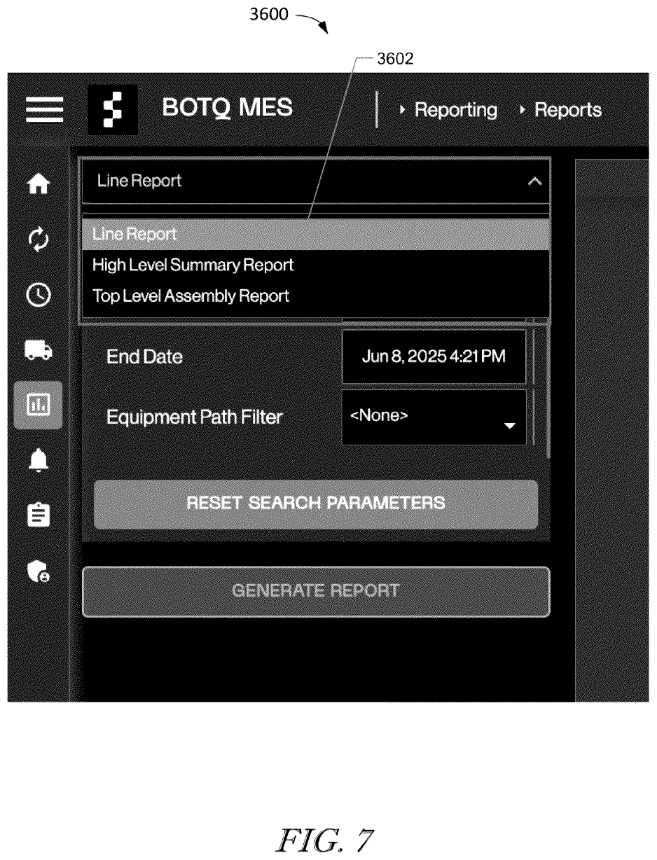

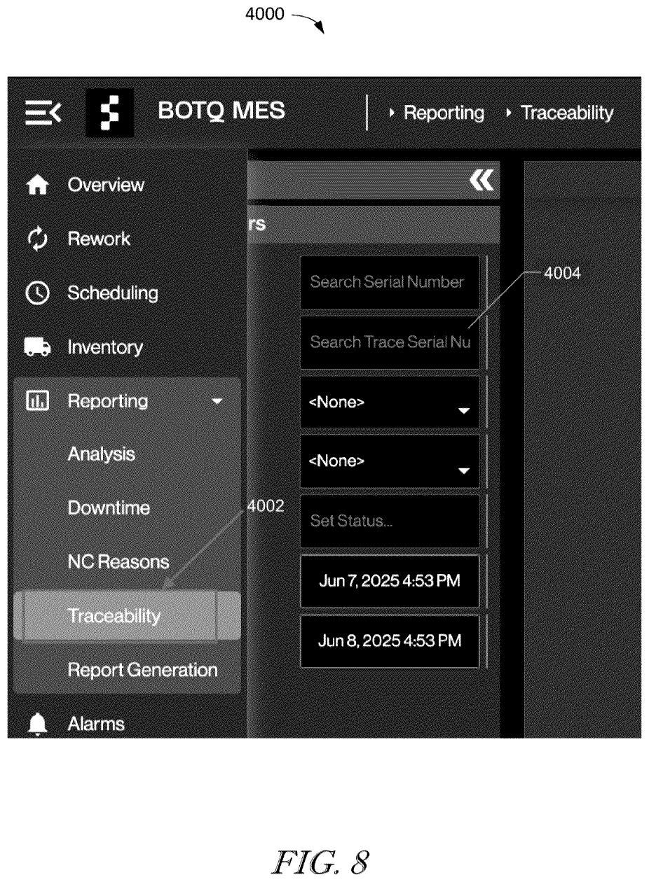

The MES provides a dedicated traceability interface 4000 accessible via a sidebar icon 4002, as illustrated in the user interface of FIG. 8. This interface 4000 allows users to perform detailed searches based on top-level assembly (TLA) serial numbers or housing serial numbers to retrieve the full lineage of a specific robotic unit or component. Filtering parameters provided in FIG. 8 allow for the selection of specific manufacturing locations, part numbers, and status indicators, as well as start and end dates for the search query. Upon entering a serial number into the “search trace serial number” field 4004 and selecting the matching result, the system is configured to present a comprehensive history of the build, allowing for a deep-dive analysis of part and process lineage. This traceability is supported by a data generation process where every constituent part is scanned at the initiation of each assembly step at the various workstations. This scanning allows the MES to link specific part serial numbers to the top-level assembly in real-time, documenting the transformation of materials as they move across the modular “unboxed” production framework.

The generation of traceability data can be further enhanced by the integration of automated tooling and real-time operator inputs. Fastening operations within the facility utilize tools that are configured with preset torque and angle values, associated with designated PSet configurations at each station. When an operator performs a fastening task, the MES automatically records the actual torque and angle values achieved, documenting these parameters alongside the operator's identifier and the station timestamp. This real-time recording allows the system to capture the precise operational data of every assembly step, from the insertion of smart joint actuators to the final structural integration of the torso. This data-driven approach allows for the maintenance of a complete digital genealogy for every humanoid robot produced, making it possible to verify that all components were installed according to predefined engineering specifications and quality standards.

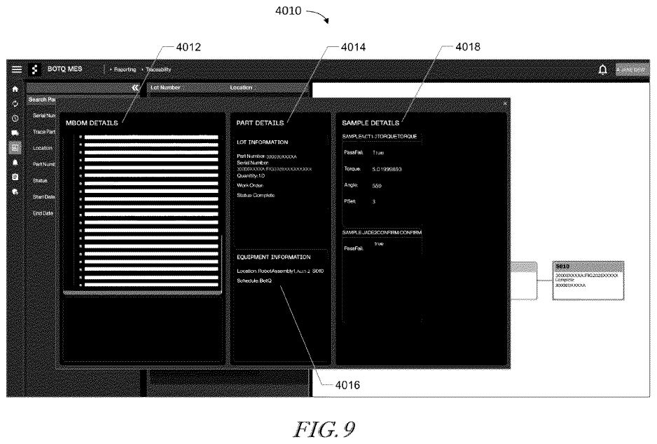

As illustrated in the TLA tree view of FIG. 9, the MES provides a graphical representation 4010 of the detailed bill of materials (BOM) and process data for a selected unit. The interface is configured with several distinct data blocks, including an “MBOM Details” pane 4012 that presents a chronological list of part instances and their associated timestamps. A “Part Details” block 4014 provides lot information, including the part number (e.g., 300000XXXXA), serial number (e.g., FIG. 2026XXXXXXXXX), quantity, and current work order status. “Equipment Information” 4016 is provided to identify the assembly location, such as “RobotAssembly1, Actuator 1-2, Station S010.” Furthermore, a “Sample Details” block 4018 is configured to display granular quality data, such as a torque value of 5.019 N-m, an angle of 559, a PSet of 3, and a Boolean pass/fail status. This interface allows for a visual exploration of the product's history, providing a structured overview of both the physical components and the quality gate results for each discrete assembly event.

FIG. 10 further illustrates a tree view 4020 of the production process plan steps, which allows users to “peel the onion” and inspect each individual action taken during the manufacturing lifecycle. Within this graphical layout, color coding is utilized to distinguish between different types of events; for example, green blocks 4022 represent operations or actions taken by the MES when moving a physical part between steps, while blue blocks 4024 signify the actual physical parts moving along the stations. Details about the parts, such as material additions or captured samples, can be accessed within these blue blocks. An example flow 4026 is depicted in FIG. 10, illustrating a specific sequence where a part with serial number #300000XXXXA completes assembly steps 4024-13 through 4024-15 and is subsequently joined with another constituent component 4028 with part #300000XXXXB. This visual mapping allows for the clear tracking of how subassemblies converge at different integration stages within the modular facility.

e. Event Logging

The manufacturing execution system is further configured with a comprehensive event log interface 4200, as depicted in FIG. 11, which provides for the browsing and analysis of historical data captured during the robotic production cycle. A dedicated event log button 4202 is provided within the system navigation sidebar, allowing authorized users to access a chronological record of manufacturing events, such as events 4206 and 4208. This interface is configured to document a wide range of occurrences in real time, including system status changes, operational hardware or software errors, and specific operator actions taken at various workstations. By preserving this detailed event history, the system allows for the monitoring of web authentication status changes, login requests from various actors, and automated tag writes from connected tooling. This auditing capability provides for a high-level understanding of the interactions between the digital MES and the physical assembly environment, ensuring that a transparent record of all shop floor activity is maintained.

As illustrated in FIG. 11, the interface includes a search box 4204 configured to allow users to perform targeted queries by entering specific identifiers to isolate relevant log data. Users can utilize this search functionality to type in a trace part number concatenated with a serial number or specify a particular station location, such as Rework1/S090, to retrieve useful information regarding specific assembly events or maintenance logs. The data displayed within the log panes can include the time of the event, the actor or entity responsible for the action, the specific action taken, and associated values such as torque results or test status. For example, the system can record detailed post-test results from end-of-line validation, button press events from confirmation screens, or login responses from the identity provider. This integrated monitoring capability provides for the rapid retrieval of information for troubleshooting or system cleanup, ensuring that the facility's digital infrastructure remains optimized and synchronized with the production plan.

f. End-of-Line (EOL) Testing

The end-of-line (EOL) testing phase is configured to support two distinct levels of validation, providing for the independent verification of individual subassemblies at the end of their respective production lines and the comprehensive assessment of the fully integrated humanoid robot. End-of-production line testing allows for the functional validation of specific hardware modules, such as joint actuators or battery packs, prior to their integration into a higher-level assembly. In contrast, the full robot EOL testing stage involves the assessment of the completed robotic unit once all structural, power, and perception modules have been integrated. For example, an actuator module such as Actuator 1 may undergo an independent EOL sequence at a dedicated station to verify torque output and encoder accuracy, while the full robot validation ensures that these actuators operate in a synchronized manner with the torso and perception systems. This tiered approach ensures that failure modes can be isolated at the component level, allowing for targeted rework before the unit proceeds to the final integration gate. The tiered progression through subsequent full-robot validation stations—from suspended self-calibration, through upper-body articular range-of-motion testing under high-torque loads with simultaneous head, neck, waist, and arm manipulation, to full-body dynamic motion testing including commanded running gait and autonomous balancing sequences—provides for the systematic verification of increasingly complex system-level behaviors that cannot be assessed at the individual component or subassembly level.

In some implementations, the MES is configured with a predictive quality gating module that continuously evaluates the probability of a subassembly passing its downstream EOL test based on process parameters collected during assembly, and is configured to divert units with a predicted failure probability exceeding a configurable threshold to a diagnostic or rework station before the unit reaches the EOL test station. The predictive quality gating module maintains a trained machine learning model, such as a gradient-boosted decision tree or a neural network, that accepts as input the set of process parameters recorded during the assembly of the subassembly, including torque and angle values from fastening operations, component lot identifiers, operator identifiers, station cycle times, environmental sensor readings such as temperature and humidity, and any inline measurement data captured during the assembly sequence. The model outputs a probability score representing the likelihood that the subassembly will fail to meet the acceptance criteria during its EOL test. This probability score is computed at the conclusion of each major assembly station and is compared against a configurable diversion threshold. If the score exceeds the threshold, the MES generates a diversion instruction that routes the unit to a diagnostic station for inspection before it consumes EOL test capacity. The predictive model is periodically retrained using the growing corpus of assembly parameter and EOL test result data stored within the MES, allowing the model to adapt to process drift, new component lots, and evolving failure modes. In some embodiments, the predictive quality gating module may further provide explainability output identifying the specific process parameters that contributed most strongly to the elevated failure probability, thereby guiding the diagnostic technician to the most likely root cause and reducing the mean time to resolution. In further embodiments, the module may operate in a shadow mode during initial deployment, generating predictions without diverting units, to allow the system to accumulate sufficient data for model validation before the gating function is activated.

In some implementations, the MES is configured with a distributed EOL test orchestrator that manages the routing of completed subassemblies and full robots across a plurality of EOL test stations based on real-time station availability, historical failure mode data, and the specific test designations associated with each unit's manufacturing genealogy. The test orchestrator maintains a directed acyclic graph (DAG) of test dependencies for each product type, where each node in the DAG represents a specific test sequence and directed edges represent prerequisite relationships between tests. When a subassembly or full robot arrives at the EOL testing area, the orchestrator evaluates the unit's current test completion state against the DAG and identifies the set of test sequences that are eligible for immediate execution based on the satisfaction of all prerequisite conditions. The orchestrator then assigns the unit to an available test station that is configured to execute one of the eligible test sequences, selecting the assignment that minimizes the expected total time to complete all remaining tests for the unit while considering the current queue depths and estimated processing times at each station. In some embodiments, the test orchestrator may further implement conditional test routing based on results from preceding test sequences. For example, if an actuator subassembly exhibits a marginal torque result during its initial EOL test that falls within a configurable borderline range between the pass and fail thresholds, the orchestrator may route the unit to an extended characterization test station for additional analysis rather than issuing an immediate pass or fail disposition. This conditional routing allows the facility to apply more rigorous testing to units that present ambiguous initial results while avoiding the application of unnecessarily extensive test sequences to units that clearly meet performance specifications, thereby optimizing the utilization of testing resources and maintaining overall EOL throughput. In further embodiments, the orchestrator may leverage machine learning models trained on historical EOL test data to predict the probability that a unit will fail a downstream test based on the results of upstream tests, enabling preemptive routing to rework stations before the unit consumes additional testing resources.

i. Production Line EOL Testing

At the terminus of each discrete production line, the facility provides for specialized EOL test stations configured to evaluate specific functional units across various manufacturing areas. For the articulation and limb cells, these include actuator EOL test stations such as those dedicated to the Actuator 1 through Actuator 6 lines, where each station is configured to verify the torque output, encoder accuracy, and thermal response of the respective actuator type. Subassembly EOL test stations are further provided for complex structural units, including tactile sensors (tactile1), torso assemblies (torsoAssembly1), and specialized motor units like thumb motors (thumbMotor1). The subassembly validation layer can extend to thumbs, fingers, hands, and shins (shin1), providing for the granular verification of the robot's dexterity and structural integrity. Battery production areas are supported by dedicated battery EOL test stations, including cell testing (celltest1), battery management system validation (bmstest1), and the main battery line (batteryMain1). Furthermore, head-specific EOL stations such as HeadEOL1 and dedicated bring-up stations are provided to manage the initial power-on and calibration sequences, ensuring that every subsystem is functional before final robot-level validation. In alternative configurations, high-volume production lines may employ parallel EOL test stations to increase throughput, where multiple units of the same type undergo simultaneous testing on adjacent test beds. In some implementations, the initiation of the EOL test sequence may be automated through barcode scanning at the station entrance, while in other implementations, a manual operator initiation step may be retained to allow for visual pre-inspection of the unit before testing commences. In yet further implementations, a statistical sampling approach may be applied to certain high-volume, low-variability component lines, wherein a representative subset of units is subjected to the full EOL test suite while the remaining units undergo a reduced verification sequence to optimize throughput without compromising overall quality assurance.

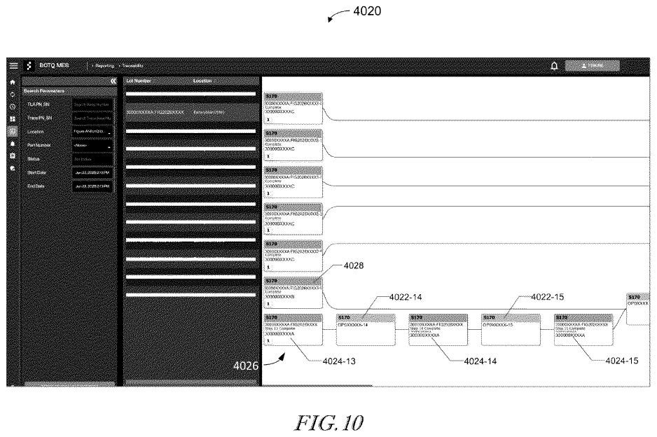

API integration between the testing hardware and the MES allows for a seamless, real-time data exchange that maintains the integrity of the manufacturing process. The MES is configured to act as the authoritative source for part readiness, utilizing working examples of API validation interface 5000 and endpoints 5002, such as validatePartForEOL, to confirm that a unit has successfully cleared all upstream assembly steps. FIG. 12 provides an operational example of this validation workflow, illustrating a POST request 5004 that includes the area name and the part barcode 5006. The system is configured to process this request and return a response body 5008 containing the validated part identifier, the associated line name, and the specific manufacturing station, such as S030. This automated handshake ensures that testing only proceeds for parts that meet the assembly standards, thereby providing the tester with the precise top-level assembly (TLA) context needed to execute the appropriate test suite.

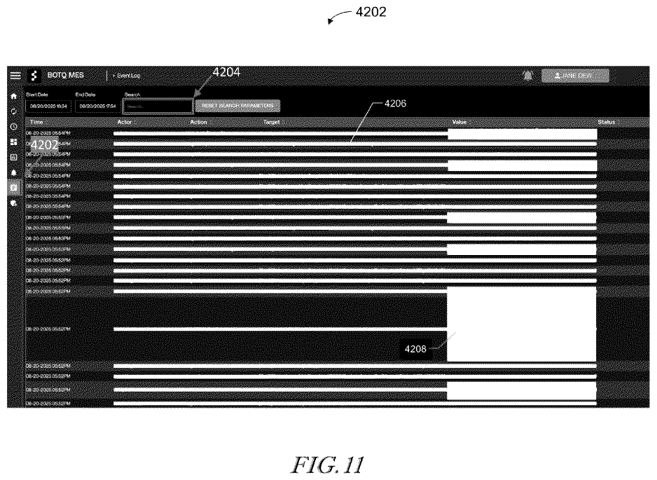

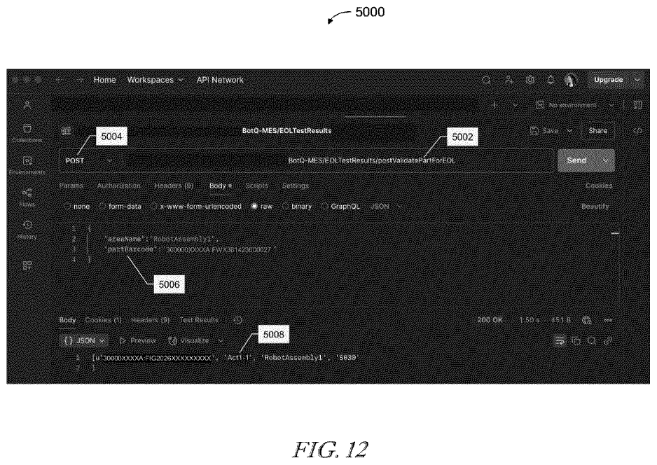

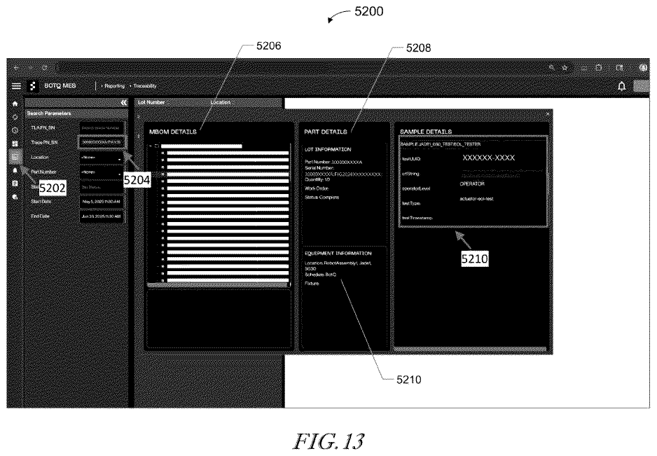

The results generated during the EOL test sequence are subsequently posted back to the MES, where they are stored within the unit's digital genealogy and can be searched and reviewed through the system interface. As shown in the operational record 5200 of FIG. 13, these results can be searched e.g., by Trace PN_SN 5204 from the Traceability menu 5202, and accessed through the “Sample Details” pane 5212 of the traceability dashboard, which is configured to record granular metrics such as the testUUID, testType, and testTimestamp. The system captures operational data including the operatorLevel and the specific designation for the actuator-eol-test, allowing for the verification of the final kinetic validation results. Similar to FIG. 9, the interface is also configured with several data blocks, including the “MBOM Details” pane 5206 for a chronological list of part instances and their associated timestamps, the “Part Details” block 5208 for lot information and current work order status, and “Equipment Information” 5210 to identify the assembly location. By appending all EOL data - - - including any subsequent retest attempts - - - to the permanent record of the top-level assembly, the MES ensures that quality assurance teams have access to a comprehensive and transparent audit trail.

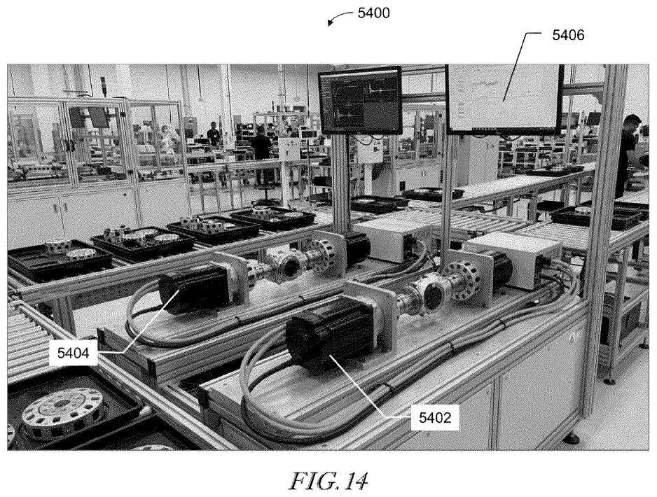

The physical implementation and operational interfaces for these various EOL stations are illustrated through representative examples of specialized hardware setups and integrated digital monitoring systems, where FIG. 14 serves as a primary example of the EOL testing station 5400 for the actuator lines. For instance, the facility is configured with specialized dynamometer (“dyno”) test beds designed to verify the performance, efficiency, and durability of the robotic joint actuators during the EOL validation phase. Dynamometer testing provides for the measurement of an electric motor's torque, rotational speed, and power output, allowing for a comprehensive analysis of the actuator's operational characteristics. By connecting a motor to a load-applying device, such as an eddy-current brake or a magnetic powder brake, the system can generate detailed torque-speed curves and identify the maximum power points of the subassembly. This methodology allows for the validation of design limits and ensures that the actuators can withstand the mechanical stresses encountered during humanoid locomotion and manipulation. Such testing methodologies provide a high level of confidence in the subassembly's long-term performance and enable the identification of efficiency anomalies prior to final robot integration.

As illustrated in FIG. 14, an end-of-line dynamometer test bed 5402 is provided specifically for the validation of an actuator, for example, the J4 elbow joint actuator. The actuator 5412 is secured within a precision fixture that allows for the alignment of the actuator's output shaft with the dynamometer's load-applying mechanism. This configuration provides the MES with real-time feedback on the joint's ability to generate the torque while maintaining consistent speed and power efficiency. Similarly, an additional dynamometer test bed 5404 is configured for the validation of another actuator type, for example, the J3 upper arm twist actuator. In this configuration, the actuator 5422 is integrated into the test bed to undergo a series of stress tests and burn-in procedures. The associated test computer screen 5406, as shown in the top of FIG. 14, provides a comprehensive test menu and real-time status indicators. This interface is configured to display results for various parameters, including input and output metrics, step encoder accuracy, speed, and torque. As indicated by the visual feedback on the screen, the system can track the progress of the burn-in cycle, showing that all test parameters have passed the designated design limits.

In some implementations, the actuator EOL test station is configured to execute a burn-in protocol with an adaptive duration that is determined in real-time based on the observed convergence of actuator performance parameters during the burn-in sequence, rather than a fixed-duration burn-in period. The adaptive burn-in protocol commands the actuator under test to execute a repeating cycle of torque and speed profiles while continuously monitoring a plurality of performance metrics including peak torque output, torque ripple magnitude, cogging torque amplitude, thermal rise rate, and encoder signal quality. For each monitored parameter, the system computes a rolling stability metric, such as the coefficient of variation of the parameter over a trailing window of the most recent N cycles, where N is a configurable parameter. The burn-in sequence is continued until the stability metric for all monitored parameters falls below a configurable convergence threshold, indicating that the actuator's performance has stabilized and that further burn-in cycles are unlikely to reveal additional failure modes. The minimum and maximum burn-in duration are bounded by configurable limits to ensure that the protocol does not terminate prematurely or extend indefinitely. By adapting the burn-in duration to the observed behavior of each individual actuator, the system reduces the average testing time for actuators that converge quickly while ensuring that actuators with slower convergence characteristics receive sufficient characterization, thereby optimizing the throughput of the actuator EOL test station without compromising the rigor of the validation. The final converged performance values, the total burn-in duration, and the stability metrics at the time of termination are recorded in the MES and appended to the actuator's digital genealogy. In some embodiments, the adaptive burn-in protocol may further incorporate a fault detection layer that monitors for non-convergent performance trends, such as a monotonically increasing thermal rise rate or a progressively degrading encoder signal, and terminates the burn-in early with a failure disposition if such trends are detected.

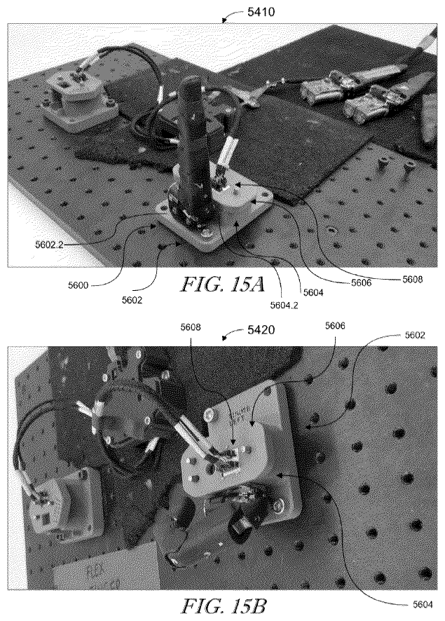

The facility's EOL infrastructure is further configured with specialized test stations dedicated to the functional validation of the robotic end-effectors, where the manufacturing process involves a tiered assembly and validation sequence. For instance, in the end-effector build, the thumb subassembly is assembled at a dedicated workstation using digital instructions that guide the operator through the integration of the internal motor, tendons, and sensors. Upon completion, the next step provides for the independent testing of the thumb module at an EOL thumb station, as illustrated in FIG. 15A and FIG. 15B. As shown in FIG. 15A, the thumb module is initially positioned in a “straight up” configuration in station 5410 to calibrate position sensors and verify baseline articular alignment. In another EOL station 5420 as illustrated in FIG. 15B, another thumb assembly is undergoing a kinetic validation sequence where the system commands various degrees of freedom (DoFs), including flexion, abduction, and movement of the metacarpophalangeal (MP) and interphalangeal (IP) joints. These granular validations allow for the detection of articular binding or motor torque anomalies before the thumb moves to higher-level integration. In both EOL stations 5410 and 5420, the thumb is attached to a jig 5600 during testing. The jig 5600 may be a stand that the thumb is attached thereto where the operator may have a clear view of the thumb while testing. The jig 5600 includes a base 5602, a post 5604 extending from a top surface 5602.2 of the base 5602, a shelf 5606 disposed on a top surface of the post 5604 and parallel to the base 5602. The top surface of the shelf 5606 includes an electronics port 5608 configured to receive wires to connect to an electronics assembly within the jig 5600 (e.g., within the post 5604) for testing the thumb. This electrical connection allows the digital instructions and data to be transferred between the thumb and the CPUs and GPUs controlled by the operator. The thumb may be attached to a side 5604.2 of the post 5604 via screws, as illustrated in FIGS. 15A and 15B, and be electrically connected to the electronics assembly within the jig 5600 to provide data during testing to the CPUs and GPUs. Alternatively, the thumb may be attached to the top surface 5602.2 of the base 5602 via screws.

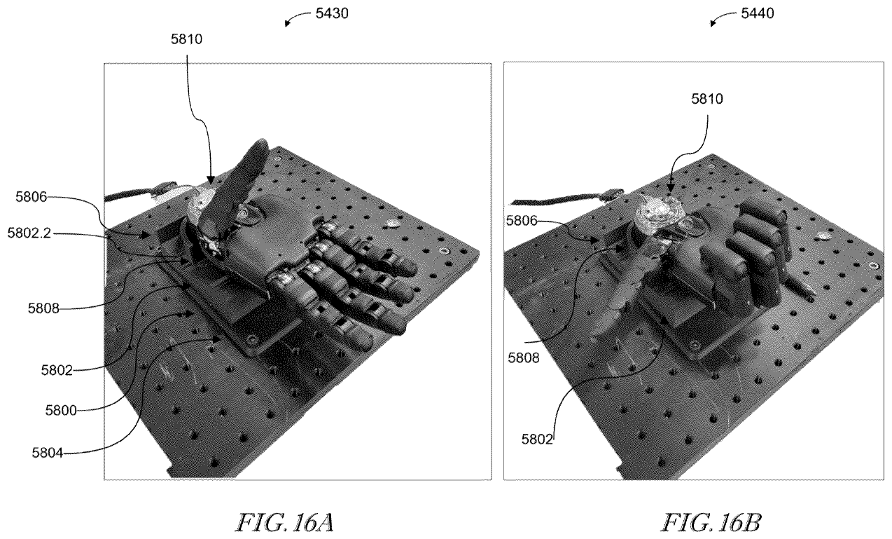

Following a successful pass result for the thumb module, the process proceeds to the next step, where the validated thumb is integrated with the palm and the four primary digits - - - comprising the index, middle, ring, and pinky fingers - - - to form the complete hand subassembly. Once this assembly is finalized, the process may proceed to the EOL testing of the fully integrated hand, as illustrated in FIG. 16A and FIG. 16B. In FIG. 16A, the hand EOL station 5430 provides for the assessment of individual digit kinetics and full range of motion for all fingers simultaneously, ensuring that the intrinsic actuators can achieve the precision for manipulation tasks. Further functional validation is illustrated in FIG. 16B, where another hand assembly is undergoing the power grip validation at EOL station 5440. In this operational example, the system validates the “power grip” functionality where the four primary fingers are commanded to retract toward the palm while the thumb is maintained in an extended or “out” position. These test configurations allow the MES to record the collective current draw and torque values associated with complex multi-digit synchronization, ensuring the end-effector is functionally capable of the robust grasping for real-world interactions before final robot-level integration. In both EOL stations 5430 and 5440, the fully integrated hand is attached to a jig 5800 during testing. The jig 5800 includes a base 5802 attached to a platform 5804. The top surface 5802.2 of the base 5802 may be step shaped. Alternatively, the top surface 5802.2 of the base may be planar. The jig 5800 further includes a first wall 5806 and a second wall 5808, each extending from the top surface 5802.2 of the base 5802. The first wall 5806 may be disposed at an end of the base 5802 and the second wall 5808 may be disposed adjacent to the first wall 5806 inland from the first wall 5806. The first wall 5806 may be planar and the second wall 5808 may be curved. The jig 5800 may further include a mount 5810 to which electronics may be mounted for EOL testing of the fully integrated hand. The mount 5810 may be disposed adjacent to the second wall 5808 and within the curved portion of the second wall 5808. The fully integrated hand may be attached to the jig 5800 such that a palm of the hand is displaced adjacent to the second wall 5808.

The facility may be further configured with specialized end-of-line test stations dedicated to the validation of primary structural modules, including the torso, shin, and pelvis assemblies. For the torso assembly, the validation station may be configured to evaluate the mechanical structure and integrated electronics after the battery module has been installed. The validation sequence provides for a comprehensive check of the internal connectors and structural architecture, initiating with a standardized startup and power-on sequence. This process allows for the verification of the torso's inertial measurement unit (IMU) and the functional response of the shoulder joint actuators. During the test, the system can perform actuator power cycles (on/off) to ensure the motor controllers initialize correctly and maintain stable communication across the power backbone. This ensures that the robot's central core is structurally and electrically sound prior to the attachment of limb modules.

Additional locomotive validation can be provided through stations configured for the shin and pelvis assemblies, focusing on the core articulation points for movement. For instance, a specialized station can be used for the EOL testing of the shin subassembly, which includes the foot integration. This sequence focuses on the verification of the knee joint (designated J15) and the ankle joint (designated J16), ensuring that the actuators can achieve the torque profiles and ranges of motion for gait stability. For the pelvis subassembly, the EOL station may provide for the integrated functional testing of the hip and spine joints alongside the primary pelvis IMU. This sequence may involve a plurality of motion commands configured to analyze the synchronization of these joint actuators. As indicated by the status on the test computer interface, the system can provide a comprehensive “all pass” result once every test in the sequence - - - from initial startup to high-speed articular movements - - - completes successfully. Following the conclusion of these structural tests, the system is configured to initiate a clean-up routine to reset the station hardware, while the MES appends the finalized result data to the unit's digital genealogy before the tested subassembly proceeds to the next manufacturing line.

The end-of-line validation for energy storage systems can also be part of the manufacturing lines and supported by large-scale equipment dedicated to the battery EOL testing phase. This testing infrastructure provides for the assessment of completed battery modules using a comprehensive battery test system 5445, which may comprise a high-density equipment cabinet housing the power electronics, load banks, and control circuitry for high-voltage validation. The facility is configured with a specialized chamber or enclosure designed to house the battery case during the validation cycle, providing for both physical containment and environmental isolation. Once the battery module is connected to the test system, the MES initiates a multi-stage testing sequence configured to analyze charge/discharge rates, thermal management profiles, and BMS communication integrity. As the sequence progresses, real-time performance data and final pass/fail results are captured by the system and stored within the unit's history. This centralized data storage allows for the maintenance of a detailed process record for every battery pack, ensuring that the energy storage systems meet the power requirements of the fully integrated humanoid platform.

In some implementations, the manufacturing facility includes a dedicated soft goods integration station positioned downstream of the primary structural and electrical assembly lines and upstream of the full-robot EOL testing stations, where a textile cover system is installed over the robot's structural housings and the MES is configured to manage a validation sequence specific to the interaction between the soft goods and the robot's kinematic and sensory systems. The soft goods integration station is configured with digital work instructions that guide the operator through the installation of textile panels over the torso, arm, and leg assemblies, including the routing of the textile through articulation points such as the shoulder, elbow, hip, and knee joints. Upon completion of the textile installation, the MES initiates a soft goods validation sequence in which the robot is commanded to execute a predefined set of joint articulation movements spanning the full range of motion for each covered joint. During these movements, the system monitors a plurality of parameters including joint motor current draw, joint encoder velocity profiles, and tactile sensor signal integrity to detect any interference, binding, or signal attenuation caused by the textile installation. The system computes a delta between the pre-textile baseline measurements recorded during the structural EOL testing phase and the post-textile measurements, and compares this delta against a configurable tolerance threshold for each joint and sensor channel. If the delta exceeds the threshold for any joint, the MES flags the specific joint for rework and presents the operator with diagnostic guidance identifying the likely cause of interference, such as excessive textile tension at a specific articulation point or improper routing of a textile seam across a sensor array. The validated post-textile measurements are appended to the robot's digital genealogy, providing a permanent record of the kinematic and sensory performance in the as-delivered configuration. In further embodiments, the soft goods validation sequence may include a thermal assessment in which the robot is commanded to execute sustained high-load joint movements while temperature sensors embedded within or adjacent to the textile monitor for localized heating that may indicate friction between the textile and the underlying housing or cable harness.

ii. Robot EOL Testing

The EOL testing framework can also extend to the full robot assembly, where the MES is configured to manage the mapping of unique TLA serial numbers to specific robot identifiers. During the full robot validation stage, the tester scans the robot-level TLA PN/SN - - - which is utilized as the primary identifier because the hand barcodes may be obscured by cover or soft goods installation - - - and the MES returns all associated mapping data, including e.g., the torso identifiers and main robot controller (MRC). This mapping allows the facility to maintain a centralized record of the robot's high-level hardware configuration relative to its unique identity. In the event that a full-robot EOL sequence fails to meet performance criteria, the unit may be routed to a dedicated Rework1 line. Within this rework environment, engineers can perform detailed debugging, troubleshooting, and root-cause analysis to address the failure. The rework workflow may include a diagnostic phase in which the MES retrieves the unit's full genealogy and EOL test data to identify the specific failure mode, followed by a component swap or repair phase in which the affected subassembly or part is replaced or refurbished according to predefined engineering procedures. Upon completion of the rework, the unit is re-entered into the production flow at the appropriate integration point and undergoes a full retest sequence to confirm that the repair has resolved the identified failure and that no additional defects have been introduced. The system provides for the repair, replacement, or refurbishment of individual parts or the entire robot assembly, ensuring that the unit is brought into compliance before undergoing a retest and proceeding toward delivery.

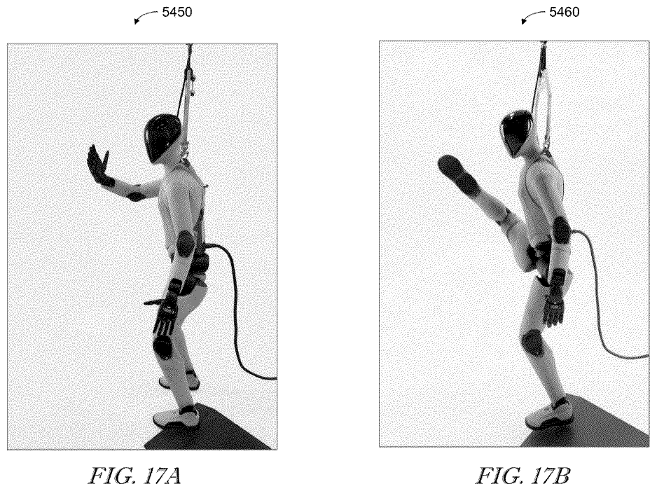

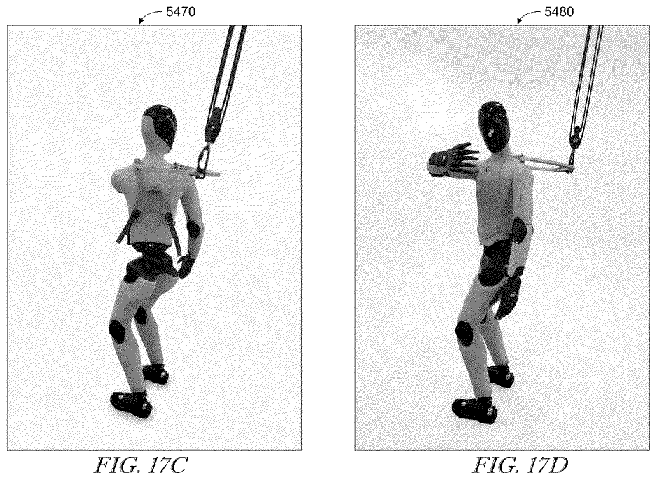

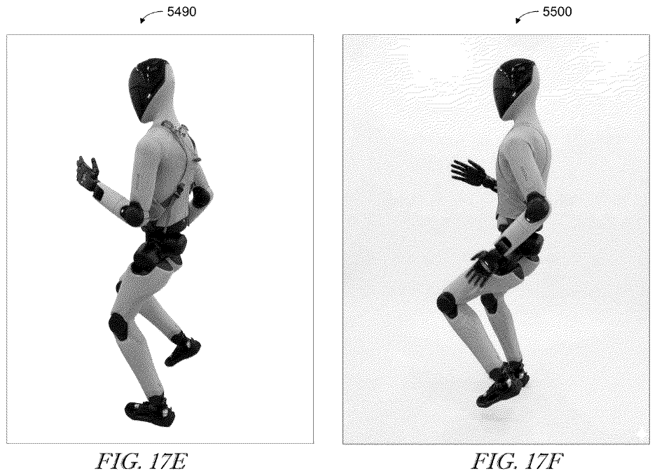

The full robot EOL testing framework can also serve as a comprehensive system-level validation gate that ensures the structural and functional operability of the humanoid platform. Although each constituent actuator, structural subassembly, and end-effector has undergone independent end-of-production-line testing, the fully integrated robot still needs to be verified to confirm that all modules work in a synchronized and stable manner. This final stage is configured across a plurality of specialized full-robot EOL stations, as illustrated in FIGS. 17A-17F.

In a first full-robot validation station, as shown in FIG. 17A and FIG. 17B, the robot is suspended from a body harness such that the feet do not touch the ground, providing for a stable environment for system-level self-calibration. This configuration allows the robot to self-identify and calibrate coordinate frames and joint kinematic offsets based on feature points identified on the end-effectors (e.g., hand and fingers) as well as the feet. As illustrated in the configuration 5450 in FIG. 17A, the robot is commanded to raise an arm and utilize its vision system to look at the right hand, while the configuration 5460 in FIG. 17B shows the robot raising the right leg to look at the right foot. These movements provide for the verification of the robot's kinematic chain and the alignment of the internal sensing systems, such as IMUs and encoders, inside the physical limbs relative to vision systems. In alternative embodiments, the self-calibration procedure may be supplemented or replaced by an external calibration methodology, such as a motion capture system comprising a plurality of infrared cameras and reflective markers positioned on the robot's limb segments, or a laser tracker-based measurement system that provides sub-millimeter positional accuracy for joint offset determination.

In some implementations, the full-robot EOL validation station is configured to leverage the humanoid robot's own onboard perception system as the primary metrology instrument for kinematic self-calibration, rather than relying solely on external measurement equipment such as laser trackers or motion capture arrays. During the self-calibration sequence, the robot is suspended in a body harness with its feet elevated from the ground plane, and the MES commands the robot to execute a predefined sequence of calibration poses in which the robot directs its head-mounted cameras toward fiducial features located on its own end-effectors and feet. For each calibration pose, the robot's onboard vision system captures one or more images of the target limb, and a calibration algorithm processes these images to compute the observed position and orientation of the fiducial features relative to the robot's head coordinate frame. The system then compares these observed positions against the nominal kinematic model stored in the robot's firmware to compute joint-level offset corrections for each actuator in the kinematic chain. This closed-loop self-referencing calibration eliminates the need for external metrology infrastructure at the calibration station, reduces the per-station capital expenditure, and produces a calibration result that is inherently matched to the robot's own perception pipeline, thereby improving the accuracy of downstream autonomous tasks that depend on hand-eye coordination. The computed joint offset corrections are stored within the robot's onboard data storage 1.2.14 and are simultaneously transmitted to the MES for inclusion in the unit's digital genealogy, allowing engineers to correlate calibration offset magnitudes with upstream assembly parameters such as specific torque signatures recorded during limb integration. In some embodiments, the self-calibration algorithm may employ a nonlinear least-squares optimization, such as a Levenberg-Marquardt solver, that simultaneously minimizes the residual error across all calibration poses to produce a globally consistent set of kinematic offsets. In further embodiments, the calibration sequence may include poses in which the robot observes both hands simultaneously using stereo vision to resolve inter-arm kinematic coupling errors that are not observable from single-limb poses alone.

In some implementations, the full-robot EOL calibration process is configured to support the simultaneous calibration of a plurality of humanoid robots by positioning two or more robots within mutual visual range and commanding each robot to observe fiducial features on the other robots in addition to its own limbs. In this multi-robot calibration configuration, a first robot and a second robot are each suspended in respective body harnesses at known spatial offsets within a calibration cell, and the MES commands each robot to execute a sequence of poses in which each robot alternately observes features on its own end-effectors and features on the other robot's end-effectors. Because the two robots share a common external reference frame defined by the calibration cell geometry, the observations of one robot's features by the other robot's perception system provide independent kinematic constraint equations that can be used to cross-validate and refine the calibration results for both robots simultaneously. This cross-referencing provides additional constraint equations that improve the observability of certain kinematic parameters, such as the absolute position of the head-mounted cameras relative to the torso coordinate frame, that may be poorly observable from self-observation alone. The multi-robot calibration results are stored independently for each unit within the MES, and the system records which other robot unit served as the cross-reference partner, allowing for the retroactive assessment of calibration quality if the cross-reference partner is subsequently found to have an uncorrected kinematic error. In some embodiments, the calibration cell may accommodate three or more robots simultaneously, where the redundant cross-observations provide sufficient degrees of freedom to resolve all kinematic parameters without requiring any external metrology equipment.

In a second full-robot EOL station, depicted in FIG. 17C and FIG. 17D, the robot is undergoing testing of the articular ranges of motion for the upper body. During this sequence shown in snapshots 5470 and 5480, the robot is commanded to execute complex movements that can include turning the head and neck, rotating the torso at the waist, and simultaneously raising or lowering the arms. This phase allows for the verification of power distribution and communication stability across the robot's structural backbone while the large actuators are under high-torque articular loads. A third validation station, illustrated in FIG. 17E and FIG. 17F, is providing for the functional testing of full-body motion and balance of the robot. In this configuration 5490 and 5500, the robot is commanded to perform dynamic actions such as running, which allow the system to analyze the whole-body control algorithms and the robot's ability to maintain gait stability and coordination.

In some implementations, the MES is configured with a gait signature fingerprinting module that captures a multi-dimensional dynamic profile for each completed humanoid robot during the full-robot EOL testing phase and associates this profile with the robot's complete manufacturing genealogy. During the dynamic motion validation sequence, the system records time-series data from a plurality of sensors including joint encoder positions, joint motor currents, IMU accelerations and angular velocities, foot force plate measurements, and actuator temperature readings while the robot executes a standardized locomotion sequence comprising at least a walking gait, a turning maneuver, and a balancing recovery from a perturbation impulse. The gait signature fingerprinting module processes these raw time-series signals to extract a feature vector comprising frequency-domain characteristics, joint synchronization metrics, center-of-pressure trajectories, and energy consumption profiles. This feature vector constitutes the robot's unique gait signature, which is stored in the MES and linked to the unit's digital genealogy. A manufacturing correlation engine within the MES is configured to perform statistical analysis across the population of gait signatures, correlating observed variations in dynamic performance with specific upstream manufacturing parameters recorded in the genealogy data, such as actuator torque signatures from actuator EOL testing, specific torque and angle values from fastening operations during limb integration, and thermal profiles observed during battery EOL testing. This correlation enables the identification of manufacturing process parameters that have a statistically significant influence on locomotion performance, thereby providing a data-driven basis for tightening tolerances on high-impact process steps and relaxing tolerances on low-impact steps. In further implementations, the gait signature may be transmitted to a cloud-based analytics platform where it is compared against field performance data collected from deployed robots, enabling a closed-loop feedback mechanism wherein field degradation patterns are traced back to specific manufacturing batch characteristics or process deviations.

The implementation of this tiered EOL testing framework provides substantial advantages in terms of quality assurance and operational resilience. By isolating failure modes at both the component subassembly level and the fully integrated robot level, the system allows for the early detection of defects, thereby preventing the waste of downstream integration effort on faulty modules. This multi-layered validation ensures that every constituent part, from the smallest tactile sensor to the main battery management system, is functionally verified before it contributes to the complex synchronized movements of the humanoid form. Furthermore, the integration of dedicated rework loops allows the facility to salvage valuable components and address assembly anomalies without halting the entire modular “unboxed” process. This data-driven feedback loop fosters a culture of continuous improvement, providing engineers with the transparent audit trails to optimize robotic designs and manufacturing methodologies, ultimately enhancing the reliability and performance of the humanoid platforms.

In some implementations, the MES is configured with a field-to-factory feedback interface that receives operational telemetry data from humanoid robots deployed in the field and correlates observed field performance anomalies with specific manufacturing parameters recorded in the digital genealogy of the affected units. The field-to-factory feedback interface is configured to receive data transmissions from the remote AI system 2780 or from individual deployed robots via a secure network connection, where these transmissions include periodic telemetry reports comprising actuator health metrics, battery degradation curves, sensor calibration drift measurements, joint backlash measurements, and thermal cycling logs. Upon receipt of a telemetry report indicating a performance anomaly, such as an actuator exhibiting torque degradation exceeding a configurable threshold or a battery module exhibiting capacity fade exceeding a configurable rate, the feedback interface queries the MES database to retrieve the complete manufacturing genealogy of the affected unit, including the specific station-level process parameters, operator identifiers, component lot numbers, and EOL test results associated with the anomalous subsystem. A root-cause analysis module within the feedback interface is configured to perform a statistical comparison between the manufacturing parameters of units exhibiting the field anomaly and a control population of units that have not exhibited the anomaly, thereby identifying manufacturing process variables that are statistically associated with the observed failure mode. The system is further configured to generate a corrective action recommendation that may include modifications to specific station-level torque specifications, adjustments to actuator burn-in durations, changes to thermal screening thresholds during battery EOL testing, or targeted rework of units sharing the identified risk factors that have not yet been deployed. In some embodiments, the feedback interface may further support predictive maintenance scheduling for deployed robots by correlating the manufacturing signatures of units currently in the field with the failure patterns observed in units exhibiting anomalies, generating proactive service alerts for units whose manufacturing profiles indicate an elevated probability of future failure.

In some implementations, the MES maintains a hierarchical digital twin architecture in which each subassembly produced within the facility is associated with a subassembly-level digital twin that captures the as-built physical parameters and calibration data for that specific unit, and these subassembly-level digital twins are dynamically composed into a full-robot digital twin at the point of final integration. During the assembly of each subassembly, the MES populates the subassembly-level digital twin with the recorded manufacturing parameters, including the measured dimensions of structural housings, the calibrated offset values for actuator encoders, the characterized torque curves from actuator EOL testing, the measured impedance values for tactile sensor arrays, and the thermal profiles observed during battery EOL testing. When the subassemblies are integrated into a full robot at the central integration zone, the MES is configured to automatically compose the subassembly-level digital twins into a unified full-robot digital twin by resolving the kinematic and electrical interfaces between the constituent subassembly models. The composed full-robot digital twin represents the specific as-built configuration of the individual robot unit, incorporating the actual measured parameters of every constituent component rather than nominal design values. This composed digital twin is then utilized during the full-robot EOL calibration sequence to initialize the robot's onboard kinematic model with the as-built parameter values, reducing the search space for the self-calibration optimization and improving the speed and accuracy of the calibration process. The composed digital twin is further transmitted to the remote AI system 2780, where it is loaded into the simulation engine 2800 to create a unit-specific simulation model that can be used for targeted performance prediction, maintenance planning, and software optimization specific to the individual robot's physical characteristics. In some embodiments, the hierarchical digital twin may be updated continuously throughout the robot's operational life as field telemetry data is received, creating a living digital representation that tracks the evolving physical state of the robot including actuator wear, battery degradation, and sensor drift.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/442,030, 19/443,231, 19/443,345, 19/536,458, 19/538,967, 19/552,233, 19/557,667, 19/557,966, 19/557,999, 19/558,158, 19/066,122, 19/392,086, 19/180,106, 19/249,517, 19/286,240, 19/319,712, 19/323,751, 19/325,415, 19/325,486, 19/329,008, 19/337,852, 19/337,899, 19/347,690, 19/347,994, 19/351,294, 19/352,959, 19/355,393, 19/355,531, 19/355,786, 19/378,092, 19/378,308; and (iii) U.S. Design patent application Ser. Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A method of manufacturing a robot, the method comprising:
obtaining a baseline measurement of at least one operational parameter of at least one actuated joint of the robot;
subsequent to obtaining the baseline measurement, installing a cover over at least a portion of the robot proximate the at least one actuated joint;
subsequent to installing the cover, causing the at least one actuated joint to execute a movement;
obtaining a post-installation measurement of the at least one operational parameter during or after the movement;
determining a difference between the baseline measurement and the post-installation measurement; and
evaluating the difference to assess whether the cover has introduced interference with the at least one actuated joint.

2. The method of claim 1, wherein the robot is a humanoid robot capable of bipedal locomotion, the humanoid robot comprising a plurality of actuators distributed across a torso assembly, at least one arm assembly, and at least one leg assembly.

3. The method of claim 1, wherein the at least one operational parameter comprises at least one of a motor current, a joint encoder velocity, or a sensor signal level associated with the at least one actuated joint.

4. The method of claim 1, wherein evaluating the difference comprises comparing the difference against a threshold, and in response to the difference exceeding the threshold, generating a rework indication for the at least one actuated joint.

5. The method of claim 1, further comprising storing the baseline measurement, the post-installation measurement, and the determined difference in a digital record associated with the robot, whereby the digital record documents performance of the robot in both a pre-installation configuration and a post-installation configuration.

6. The method of claim 1, wherein the baseline measurement is obtained during a test performed on a subassembly of the robot containing the at least one actuated joint prior to integration of the subassembly into the robot.

7. The method of claim 1, wherein the method is performed within a manufacturing facility comprising a manufacturing execution system that tracks the robot through a plurality of production stations and maintains a digital genealogy record for the robot, and wherein the manufacturing execution system initiates the movement and records the post-installation measurement as part of the digital genealogy record.

8. A method of manufacturing a robot, the method comprising:
fabricating a first component of the robot;
prior to testing the first component, confirming via a computer system that the first component has satisfied one or more upstream process conditions;
upon the confirming, performing a first test on the first component and storing first test results in a record associated with the robot maintained by the computer system;
subsequent to the first component passing the first test, integrating the first component with at least a second component to form an integrated robot assembly; and
performing a second test on the integrated robot assembly, the second test comprising causing the integrated robot assembly to execute a sequence that evaluates the first component and the at least second component operating as an integrated unit, and storing second test results in the record;
whereby the record maintained by the computer system comprises test results spanning both component-level and system-level validation of the robot.

9. The method of claim 8, wherein the robot is a humanoid robot, and wherein the first component comprises an actuator subassembly and the at least second component comprises a structural subassembly, and wherein the second test comprises commanding the humanoid robot to execute a locomotion or manipulation sequence.

10. The method of claim 8, wherein in response to the computer system determining that the first component has not satisfied the one or more upstream process conditions, the computer system prevents the first test from being initiated and presents a notification identifying an upstream process condition that remains unsatisfied.

11. The method of claim 8, wherein the second test comprises:
supporting the integrated robot assembly such that the robot is not in contact with a ground surface;
causing the robot to direct onboard sensors toward features on at least one portion of the robot; and
computing calibration corrections based on observations from the onboard sensors relative to a model of the robot, wherein the onboard sensors serve as a metrology instrument for self-calibration of the robot.

12. The method of claim 11, wherein the calibration corrections are stored onboard the robot and transmitted to the computer system for inclusion in the record, whereby the calibration corrections are correlated with upstream process parameters recorded during fabrication.

13. The method of claim 8, further comprising:
receiving, by the computer system, telemetry data from the robot after the robot has been deployed;
correlating a performance anomaly indicated by the telemetry data with parameters in the record; and
generating a corrective action recommendation based on a comparison between the parameters of the robot exhibiting the anomaly and parameters of other robots.

14. The method of claim 8, wherein the computer system comprises a predictive module that accepts process parameters recorded during fabrication of the first component and outputs a score representing a likelihood that the first component will fail the first test, and wherein in response to the score exceeding a threshold, the computer system diverts the first component to a diagnostic process prior to the first test.

15. A method of manufacturing a robot, the method comprising:
initiating a burn-in sequence on a component of the robot, the burn-in sequence comprising causing the component to execute repeating operational cycles;
during the burn-in sequence, monitoring at least one performance metric of the component;
computing a stability indicator based on variation of the at least one performance metric across a plurality of the operational cycles;
determining that the stability indicator satisfies a convergence criterion; and
in response to the stability indicator satisfying the convergence criterion, terminating the burn-in sequence, whereby a duration of the burn-in sequence is determined based on observed performance behavior of the individual component.

16. The method of claim 15, wherein the component is an actuator subassembly of a humanoid robot, the actuator subassembly comprising a motor and an encoder, and wherein subsequent to terminating the burn-in sequence, the method further comprises integrating the actuator subassembly into the humanoid robot.

17. The method of claim 15, wherein the stability indicator comprises a coefficient of variation of the at least one performance metric computed over a trailing window of a most recent N operational cycles, and wherein the convergence criterion comprises the coefficient of variation falling below a threshold.

18. The method of claim 15, wherein the at least one performance metric comprises at least two of: a peak torque output, a torque ripple magnitude, a cogging torque amplitude, a thermal rise rate, or an encoder signal quality, and wherein the stability indicator is computed for each, and wherein the burn-in sequence is terminated in response to the stability indicator satisfying the convergence criterion for each.

19. The method of claim 15, further comprising monitoring for a non-convergent trend in the at least one performance metric, the non-convergent trend comprising a progressively worsening value over consecutive operational cycles, and in response to detecting the non-convergent trend, terminating the burn-in sequence with a failure disposition, whereby components exhibiting degradation during burn-in are identified.

20. The method of claim 15, further comprising storing, in a digital record associated with the component, converged values of the at least one performance metric and a total duration of the burn-in sequence, and associating the digital record with a specific robot into which the component is integrated.

21. The method of claim 20, further comprising, subsequent to integrating the component into the robot, performing a system-level test on the robot and correlating a system-level performance characteristic with the converged values stored in the digital record, whereby relationships between component-level burn-in characteristics and system-level performance are identifiable across a population of manufactured robots.
